(19) United States
(12) Patent Application Publication
(10) Pub. No.: US 2016/0156579 A1
(43) Pub. Date: Jun. 2, 2016

(54) SYSTEMS AND METHODS FOR ESTIMATING USER JUDGMENT BASED ON PARTIAL FEEDBACK AND APPLYING IT TO MESSAGE CATEGORIZATION

(71) Applicant: Google Inc., Mountain View, CA (US)

(72) Inventor: Tobias Kaufmann, Zurich (CH)

(21) Appl. No.: 14/557,307

(22) Filed: Dec. 1, 2014

(51) Int. Cl. H04L 12/58

(52) U.S. Cl. CPC H04L 51/22; H04L 51/12

(57) ABSTRACT

Messages in a first and second plurality of messages are respectively classified using a first and second classifier into message categories in a set of message categories, with messages in the first and second plurality of messages being associated with message reputation carriers in a plurality of message reputation carriers. The classified messages are delivered to recipients and message category correction events are collected. Correction weights are determined for correction types associated with the set of message categories using the initial message categorizations and the category correction events. At least a subset of the calculated correction weights is used to determine a probability or likelihood that a particular message reputation carrier in the plurality of carriers is associated with a first message category in the set of message categories. The particular carrier is whitelisted to the first message category when the calculated probability or likelihood satisfies a whitelisting criterion.

### TECHNICAL FIELD

This specification describes technologies relating to an email system in general, and specifically to systems and methods for optimizing message classifiers based on partial feedback from message recipients.

### BACKGROUND

Electronic messaging, such as through email, is a powerful communication tool for the dissemination of information. However, the ease of sending messages can result in a recipient receiving large numbers of messages in a single day. This is because, in addition to message sent by actual people, a recipient may receive messages generated by machines from third party services such as airlines, invitation generating companies, courier services, and social media sites. These messages may include confirmations, notifications, promotions, social media updates, and messages from collaboration system.

The classification of messages into message categories helps recipients parse through all of these messages. For example, having messages classified into just a few basic categories (e.g., promotions, social, updates, and forums) greatly assists a recipient in determining which messages to review, and allows the recipient to review messages that are of a similar type at the same time (e.g., all personal messages at the same time, all promotional messages at the same time, etc.). Moreover, such classification helps to put similar messages in the same place, for ease of comparison. As such, message classification provides a more efficient, productive environment for recipients.

Disagreement between the classification assigned to messages by automated classifiers and recipient opinion can be detected, and measured, through recipient initiated message category correction events. A recipient initiated message category correction event occurs when a user changes the message category assigned to a message by an automated classifier to a different message category. For instance, consider the case in which an automated classifier classifies a given message as a promotion. The message is then delivered to the recipient of the message. The message recipient uses a messaging application in which messages of each message category are arranged in separate folders, clusters or objects. Accordingly, the message recipient sees the message, classified as a promotion, in the separate folder, cluster or object that contains the promotion messages. The user does not believe the message is a promotion, but rather is a social media message. Therefore, the user moves the message from the folder, cluster or object associated with promotional messages to the folder, cluster or object associated with social media messages. This manual reassignment of the message is an example of a recipient initiated message category correction event.

In principle, recipient initiated message category correction events can be used in the further training of classifiers so that they are more aligned with recipient judgment. However, there is a drawback with the direct use of recipient initiated message category correction events for such training purposes. Recipients do not always correct the category of incoming messages even though they may disagree with their categorization. Worse still, the degree of user non-responsiveness may vary depending on the correction event type. For instance, consider a set of possible message categories {A, B, C} for which there are therefore six possible correction event types: {A→B, A→C, B→A, B→C, C→A, and C→B}, where the first type X in the category pair X→Y, is assigned by an automated classifier and the second type Y in the category pair is reassigned by the recipient. The problem is the correction rate for the six possible correction event types is not guaranteed to be the same. For instance, recipients may fail to make an A→B type correction when they deem such a correction appropriate (where the message was classified as message category A by an automated classifier but the recipient believes the message should be in message category B) more often then they fail to make an A→C type correction. The reason for this could be that users believe an A→C type correction is more important to make than an A→B type correction. Similar imbalance across the entire set of possible correction event types is possible.

In addition to the potential for improved training of classifiers, recipient initiated message category correction provides the potential of improved whitelisting (classification) of particular senders (or other forms of reputation carriers) to specific message categories. Such whitelisting takes the burden off of classifier driven message classification. Once a given message sender is reliably whitelisted to a particular category, messages from that sender do not need to be classified by classifiers, thereby reducing the chances that the messages from the given message sender will be misclassified. However, the process of reliably whitelisting message senders to particular categories using recipient initiated message category correction suffers from the same drawbacks above. That is, users do not always correct the message category of messages that they deem to be incorrectly categorized and, moreover, this failure to correct message categories may depend on the type of correction event X→Y type.

The above identified technical problems are reduced or eliminated by the systems and methods disclosed herein.

### SUMMARY

Technical solutions (e.g., computing systems, methods, and non-transitory computer readable storage mediums) for optimizing message classifiers based on partial feedback from message recipients are provided in the present application.

The following presents a summary of the invention in order to provide a basic understanding of some of the aspects of the invention. This summary is not an extensive overview of the invention. It is not intended to identify key/critical elements of the invention or to delineate the scope of the invention. Its sole purpose is to present some of the concepts of the invention in a simplified form as a prelude to the more detailed description that is presented later.

Various embodiments of systems, methods and devices within the scope of the appended claims each have several aspects, no single one of which is solely responsible for the desirable attributes described herein. Without limiting the scope of the appended claims, some prominent features are described herein. After considering this discussion, and particularly after reading the section entitled “Detailed Description” one will understand how the features of various embodiments are used

In some implementations, a method is provided for whitelisting messages associated with a first message reputation carrier (e.g., from a first sender, having a first message template, etc.) to a first category in a plurality of categories (e.g., promotions, social, updates, and forums). The method comprises, at a computer system having one or more processors and memory storing one or more programs for execution by the one or more processors, classifying each message in a first plurality of messages using a first classifier, thereby independently identifying an initial message category in a set of message categories for each respective message in the first plurality of messages. The first plurality of messages includes at least one respective message associated with each message reputation carrier in a plurality of message reputation carriers (e.g., at least one respective message from each sender in a plurality of senders). The plurality of messages reputation carriers includes the first message reputation carrier. Typically, the first classifier is a single classifier. However, it is possible that the first classifier consists of multiple classifiers. In such embodiments, the output of each such classifier is combined (e.g. by averaging, multiplication, or some other combinatorial operation such as a decision tree) in order to make a final decision on the category of messages in the first plurality of messages.

The method further comprises classifying each message in a second plurality of messages using a second classifier, thereby independently identifying an initial message category in the set of message categories for each respective message in the second plurality of messages. The second plurality of messages includes at least one respective message associated with each message reputation carrier in a plurality of message reputation carriers (e.g., at least one respective message from each sender in the same plurality of senders as the first plurality of messages, in embodiments where message reputation carrier is equated to sender reputation). Typically, the second classifier, like the first classifier, is a single classifier. However, it is possible that the second classifier consists of multiple classifiers. In such embodiments, the output of each such classifier is combined (e.g. by averaging, multiplication, or some other combinatorial operation such as a decision tree) in order to make a final decision on the category of message in the second plurality of messages.

The first and second plurality of messages are each delivered to a plurality of recipients with a designation of the message category of each respective message in the first and second plurality of messages, as respectively determined by the first and second classifier. Each message in the first and second plurality of messages includes at least one recipient in the plurality of recipients. Typically, each such recipient is associated with a remote client device.

Recipient initiated message category correction events for messages in the first and second plurality of messages is collected from the plurality of recipients. The correction events are then aggregated in some embodiments. For example, in some embodiments, the data is aggregated over a time window of an hour, a day, or a week. In some embodiments this time window is marked in relation to when the message has been delivered. In some embodiments this time window is marked in relation to when the message has been sent. A message category correction event occurs when the recipient of a message manually changes the category of a message to a category other than the category initially assigned to the message by the first or second classifier.

The given set of message categories is associated with a defined set of correction types, which constitutes all the possible correction types a recipient can enact on a received message. For instance, the set of message categories {A, B, C} is associated with six possible correction types: {A→B, A→C, B→A, B→C, C→A, and C→B}, where the first category type X in the correction type X→Y is assigned by the first or second classifier to a given message and the second category type Y in the correction type X→Y is the category to which recipient assigned the given message, where X≠Y. In the method, a correction weight for each respective correction type associated with the set of message categories is determined. Such correction weights compensate for the tendency of recipients to not correct the message categories of received messages. Because this tendency can vary depending on the correction type, in some embodiments, there is a unique correction weight for each possible correction type. In some embodiments, correction weights are determined for each respective correction type associated with the set of message categories using (i) the initial message category for each respective message in the first plurality of messages assigned by the first classifier, (ii) the initial message category for each respective message in the second plurality of messages assigned by the second classifier, and (iii) the recipient initiated message category correction events for messages in the first and second plurality of messages as disclosed herein.

The method continues by using the correction weight for each correction type associated with the set of message categories to determine a probability or likelihood that messages associated with the first message reputation carrier are further associated with a first message category in the set of message categories. Messages associated with the first message reputation carrier (e.g., from a first sender) are whitelisted to the first message category when the calculated probability or likelihood satisfies a whitelisting criterion.

In some embodiments, the set of message categories comprises any combination of promotions, social, updates, forums, travel, finance, and receipts. In some embodiments, the first classifier and the second classifier are the same classifier. In some such embodiments, the first plurality of messages is classified by the classifier at a time before one or more message reputation carriers in the plurality of message reputation carriers are whitelisted to a message category in the set of message categories and the second plurality of messages is classified by the classifier at a time after the one or more message reputation carriers in the plurality of message reputation carriers are whitelisted to the message category.

In some embodiments, determination of the correction weight for each respective correction type associated with the set of message categories comprises minimizing the loss function:

$$loss = {\sum }_{i , j \neq i , m} {( {p}_{i , j , m} - {w}_{i , j} \cdot {c}_{i , j , m} / {N}_{m} )}^{2} + {\sum }_{i , m} {( {\sum }_{j} {p}_{i , j , m} - {c}_{i , j , m} / {N}_{m} )}^{2} + {\sum }_{j , k} {( {\sum }_{i} {p}_{i , j , 2 k} - {p}_{i , j , 2 k + 1} )}^{2}$$

for the correction weight. Here, m is in the range 0≦m<2K, K is the number of message reputation carriers (e.g., senders) in the plurality of message reputation carriers, observations 2k and 2k+1 are associated with the same message reputation carrier in the plurality of message reputation carriers, and k is in the range 0≦k<K. Further, i and j are the i^{th} and j^{th} message categories in the set of message categories. Further, w_{i,j} is a respective correction weight associated with the set of message categories for correction between the i^{th} and j^{th} message categories in the set of message categories, where the first or second classifier initially classifies a message as message category i and recipients in the plurality of recipients then classify the message as message category j, p_{i,j,m} is the probability, that a message from observation m is categorized as category i and that its recipient judges the message to be of category j (here, “observation” means a plurality of messages from a single sender that were classified with the same classifier). An “observation” can take the form of a confusion matrix of message categorization correction events built from those messages in the first plurality of messages (for 2k) or the second plurality of messages (for 2k+1) that are from a given message reputation carrier associated with the observation. In other words, in some embodiments, an observation is a confusion matrix of message categorization events for a given message reputation carrier. The expression c_{i,j,m} is the number of messages in observation m (which in turn is associated with a given message reputation carrier) that recipients in the plurality of recipients change from the message category i, which was assigned by the first or second classifier, to the message category j. The expression Nₘ is the number of messages in the combination of the first plurality of messages and the second plurality of messages that are associated with observation m (which is in turn associated with a given message reputation carrier). The expression p_{i,j,2k} is the probability, that a message from observation 2k is categorized as category i and that its recipient judges the message to be of category j (here, “observation” means a plurality of messages from single sender k that were classified with the same classifier). The expression p_{i,j,2k+1} is the probability, that a message from observation 2k+1 is categorized as category i and that its recipient judges the message to be of category j. In some embodiments, the corrections weights are forced to be equal. In some embodiments, the loss function is regularized.

In some embodiments, the determination of a correction weight for each respective correction type associated with the set of message categories comprises minimizing the loss function:

$$loss = {\sum }_{i , j \neq i , m} {( {p}_{i , j , m} - {w}_{f ( i , j )} \cdot {c}_{i , j , m} / {N}_{m} )}^{2} + {\sum }_{i , m} {( {\sum }_{j} {p}_{i , j , m} - {c}_{i , j , m} / {N}_{m} )}^{2} + {\sum }_{j , k} {( {\sum }_{i} {p}_{i , j , 2 k} - {p}_{i , j , 2 k + 1} )}^{2} + λ {\sum }_{i} {w}_{i}^{2}$$

for the respective correction weight, where m, i, j, are defined as above and w_{f(i,j)} is a respective correction weight associated with the set of message categories for correction between any first and second message categories in the set of message categories, where the first or second classifier initially classifies a message to the first message category and recipients in the plurality of recipients then classify the message to the second message category. The values p_{i,j,m}, c_{i,j,m}, Nₘ, p_{i,j,2k}, p_{i,j,2k+1} are also as defined above. The value λ is a constant, and wᵢ² is a weight constant for message category i. In some embodiments the loss function is solved by a gradient descent approach.

In some embodiments, the mismatch between (A) the empirical data, including the initial message category for each respective message in the first plurality of messages assigned by the first classifier, (ii) the initial message category for each respective message in the second plurality of messages assigned by the second classifier, and (iii) the recipient initiated message category correction events for messages in the first and second plurality of messages, and (B) a model for a set of model parameters is represented by a loss function that is solved by a gradient descent approach (e.g., Newton method, a Broyden-Fletcher-Goldfarb-Shanno (BFGS) algorithm, or a limited memory BFGS algorithm) for the correction weight for each respective correction type associated with the set of message categories.

In some embodiments, the determination of the probability or likelihood, P(C=k), that messages associated with the first message reputation carrier are further associated with the first message category in the set of message categories, using a correction weight for a correction type associated with the set of message categories, is determined by:

$$P ( C = k ) = ( {\sum }_{i \neq k} {c}_{ik} \cdot {q}_{ik}^{- 1} - {\sum }_{j \neq k} {c}_{jk} \cdot {q}_{kj}^{- 1} + {\sum }_{j} {c}_{kj} ) / N$$

where k is the first message category, qᵢₖ⁻¹ is a correction weight for messages assigned by the first or second classifier to message category i that are then assigned by message recipients to message category k, where i≠k, and i is a message category in the set of message categories, qₖⱼ⁻¹ is a correction weight for messages assigned by the first or second classifier to message category k that are then assigned by message recipients to message category j, where k≠j, and j is a message category in the set of message categories. Further, cᵢₖ is a count of messages in the first and second plurality of messages that are assigned by the first or second classifier to message category i that are then assigned by message recipients to message category k, cₖⱼ is a count of messages in the first and second plurality of messages that are assigned by the first or second classifier to message category k that are then assigned by message recipients to message category j, and N is the number of messages in the first and second plurality of messages that are associated with the first message reputation carrier (e.g., sent by the first sender).

In some embodiments, the method further comprises, upon whitelisting messages associated with the first message reputation carrier to the first message category, classifying each message in a third plurality of messages associated with the first message reputation carrier into the whitelisted message category for the message reputation carrier, and delivering the classified third plurality of messages associated with the first message reputation carrier to recipients specified by the third plurality of messages.

In some embodiments, the whitelisting criterion is a threshold probability or likelihood, and the calculated probability or likelihood satisfies the whitelisting criterion when the calculated probability or likelihood is equal to or greater than the threshold probability or likelihood.

In some embodiments the first classifier and the second classifier are the same classifier and this classifier consists of a single neural network with the same trained weights. In such embodiments, the first plurality of messages are classified by this neural network at a time before one or more message reputation carriers in the plurality of message reputation carriers are whitelisted to a message category in the set of message categories, and the second plurality of messages are classified by the neural network at a time after the one or more message reputation carriers in the plurality of message reputation carriers are whitelisted to the message category. In alternative embodiments, the second classifier differs from the first classifier in that the second classifier includes whitelisted message reputation carriers in the plurality of message reputation carriers. That is, in the second classifier, if a message is associated with a whitelisted message reputation carrier, the message is categorized to a whitelisted category associated with the message reputation carrier. Thus, in the example where the first classifier is neural network, messages are classified in accordance with the output of the neural network of the first classifier. Likewise, the second classifier classifies messages in accordance with the output of the neural network of the second classifier unless such messages are associated a whitelisted message reputation carrier. In such instances, the messages are categorized to the whitelisted category associated with the message reputation carrier.

In some embodiments, the first classifier and the second classifier are the same classifier and the method further comprises retraining the classifier using the probability or likelihood that the first message reputation carrier is associated with the first message category in the set of message categories. In some embodiments, the second classifier includes whitelisted message reputation carriers in the plurality of message reputation carriers.

In some embodiments, each recipient in the plurality of recipients is associated with a different client in a plurality of clients and the delivering the first and second plurality of messages comprises delivering each respective message in the first and second plurality of message to the client in the plurality of clients that is associated with the respective message.

In some embodiments, the first classifier is a single first classifier and the second classifier is a single second classifier. In some such embodiments, the first classifier and the second classifier are the same classifier. In other embodiments, the first classifier is different than the second classifier.

Another aspect of the present disclosure provides a computing system comprising one or more processors and memory storing one or more programs to be executed by the one or more processors. The one or more programs comprise instructions for classifying each message in a first plurality of messages using a first classifier thereby independently identifying an initial message category in a set of message categories for each respective message in the first plurality of messages. The first plurality of messages includes at least one respective message associated with each message reputation carrier in a plurality of message reputation carriers and the plurality of message reputation carriers includes a first message reputation carrier. Each message in a second plurality of messages is classified using a second classifier, thereby independently identifying an initial message category in the set of message categories for each respective message in the second plurality of messages, where the second plurality of messages includes at least one respective message associated each message reputation carrier in the plurality of message reputation carriers. The first and second plurality of messages are each delivered to a plurality of recipients with a designation of the message category of each respective message in the first and second plurality of messages, as respectively determined by the first and second classifier. Recipient initiated message category correction events are collected for messages in the first and second plurality of messages. A correction weight is determined for each respective correction type associated with the set of message categories using (i) the initial message category for each respective message in the first plurality of messages assigned by the first classifier, (ii) the initial message category for each respective message in the second plurality of messages assigned by the second classifier, and (iii) the recipient initiated message category correction events for messages in the first and second plurality of messages. Correction weights and correction counts for correction types associated with the set of message categories are used to determine a probability or likelihood that the first message reputation carrier is associated with a first message category in the set of message categories. The first message reputation carrier is whitelisted to the first message category when the calculated probability or likelihood satisfies a whitelisting criterion.

Another aspect of the present disclosure provides a non-transitory computer readable storage medium storing one or more programs configured for execution by a computer. The one or more programs comprising instructions for classifying each message in a first plurality of messages using a first classifier thereby independently identifying an initial message category in a set of message categories for each respective message in the first plurality of messages. The first plurality of messages includes at least one respective message associated with each message reputation carrier in a plurality of message reputation carriers. The plurality of message reputation carriers includes the first message reputation carrier. Each message in a second plurality of messages is classified using a second classifier thereby independently identifying an initial message category in the set of message categories for each respective message in the second plurality of messages. The second plurality of messages includes at least one respective message associated with each message reputation carrier in the plurality of message reputation carriers. The first and second plurality of messages is delivered to a plurality of recipients with a designation of the message category of each respective message in the first and second plurality of messages, as respectively determined by the first and second classifier. Recipient initiated message category correction events are collected for messages in the first and second plurality of messages. In some embodiments, from this data, message correction events in a given predetermined time window from the plurality of recipients are aggregated. A correction weight is determined for each respective correction type associated with the set of message categories using (i) the initial message category for each respective message in the first plurality of messages assigned by the first classifier, (ii) the initial message category for each respective message in the second plurality of messages assigned by the second classifier, and (iii) the recipient initiated message category correction events for messages in the first and second plurality of messages. Correction weights and correction counts for correction types associated with the set of message categories is used to determine a probability or likelihood that the first message reputation carriers is associated with a first message category in the set of message categories. The first message reputation carrier is whitelisted to the first message category when the calculated probability or likelihood satisfies a whitelisting criterion. Thereafter, messages associated with the first message reputation carrier are themselves whitelisted to the whitelisting criterion of the first message reputation carrier.

Thus, these methods, systems, and non-transitory computer readable storage medium provide new, less cumbersome, more efficient ways to optimize message classifiers based on partial feedback from message recipients in accordance with one or more user categorization actions.

### BRIEF DESCRIPTION OF THE DRAWINGS

The implementations disclosed herein are illustrated by way of example, and not by way of limitation, in the figures of the accompanying drawings. Like reference numerals refer to corresponding parts throughout the drawings.

FIG. 1 is an example block diagram illustrating a computing system, in accordance with some implementations.

FIG. 2 is an example block diagram illustrating a computing device, in accordance with some implementations.

FIG. 3 is an example block diagram illustrating a computing system, in accordance with some implementations.

FIG. 4 is an example flow chart illustrating a method for whitelisting a message reputation carrier to a particular message category, in accordance with some implementations.

FIG. 5 is a user interface in a device based message application that enables message recipients to change the category of messages in accordance with some embodiments.

FIGS. 6A, 6B, 6C, 6D, 6E, and 6F provide a flow chart of methods of whitelisting a message reputation carrier to a message category in accordance with some implementations.

### DETAILED DESCRIPTION

The implementations described herein provide various technical solutions to improving the categorization of electronic messages generally, and to improving classifiers that automatically determine the category of electronic messages, by providing techniques for estimating the lack of responsiveness of users when they perceive that certain messages have been incorrectly categorized. Such information can ultimately be used to whitelist particular message reputation carriers to particular categories, as detailed in the present disclosure and/or to retrain or further train classifiers. Details of implementations are now described in relation to the Figures.

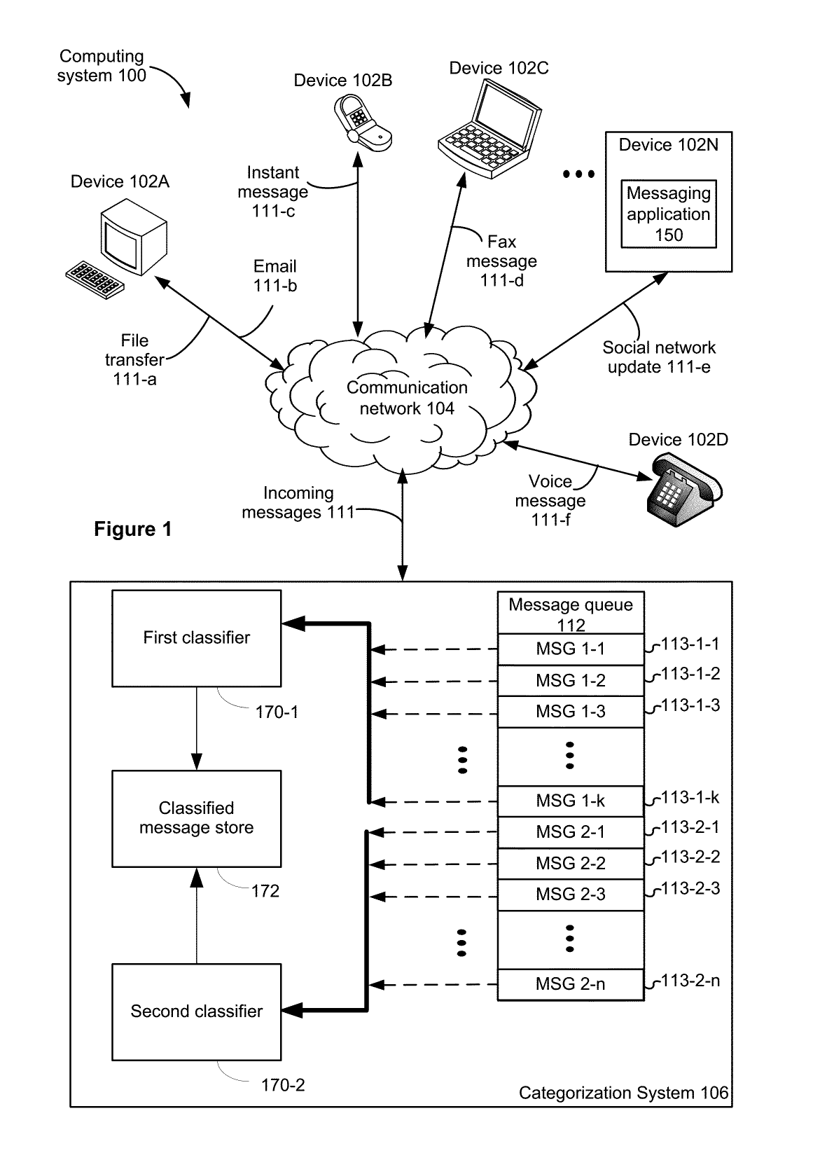

FIG. 1 is a block diagram illustrating a computing system 100, in accordance with some implementations. In some implementations, the computing system 100 includes one or more devices 102 (e.g., device 102A, 102B, 102C, 102D, . . . , and 102N), a communication network 104, and a categorization system 106. In some implementations, a device 102 is a phone (mobile or landline, smart phone or otherwise), a tablet, a computer (mobile or otherwise), a fax machine, or an audio/video recorder.

In some implementations, a device 102 obtains an electronic message associated with a reputation carrier (e.g., drafted or generated by a user of the device 102), and transmits the electronic message to the categorization system 106 for displaying with other electronic messages. For example, after determining that user Jack sends an electronic message to user Mary, the device 102 transmits the electronic message to the categorization system 106, which processes the electronic message into an object for display in a listing of electronic messages.

In some implementations, an electronic message is a file transfer 111-a (e.g., a photo, document, or video download/upload), an email 111-b, an instant message 111-c, a fax message 111-d, a social network update 111-e, or a voice message 111-f. In some implementations, an electronic message is contact information, an indication of a document, a calendar entry, an email label, a recent search query, a suggested search query, or a web search result.

In some implementations, a device 102 includes a messaging application 150. In some implementations, the messaging application 150 processes incoming and outgoing electronic messages into and from the device 102, such as an outgoing email sent by a user of the device 102 to another user, and a chat message by another user to a user of the device 102. In some embodiments the messaging application 150 is an e-mail application.

In some implementations, the communication network 104 interconnects one or more devices 102 with each other, and with the categorization system 106. In some implementations, the communication network 104 optionally includes the Internet, one or more local area networks (LANs), one or more wide area networks (WANs), other types of networks, or a combination of such networks.

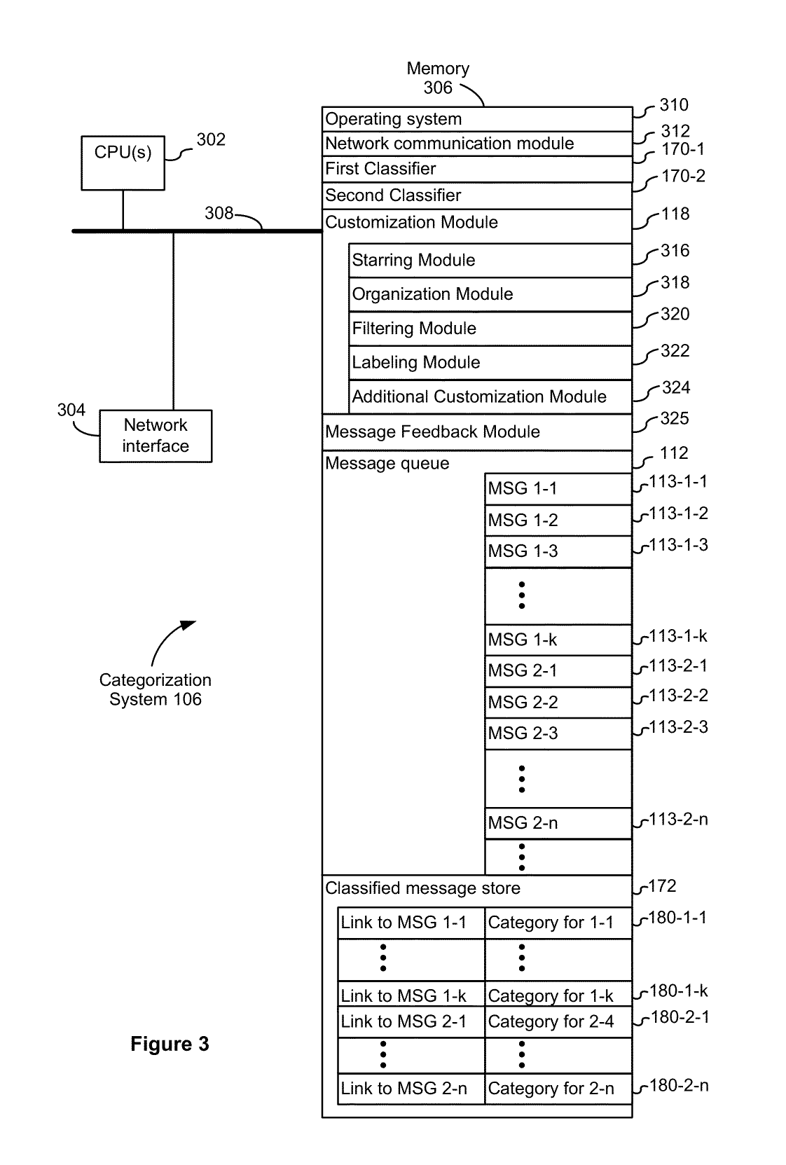

With reference to FIGS. 1 and 3, in some implementations, the classification system 106 includes a first classifier 170-1, a second classifier 170-2, a message queue 112 that includes a first plurality of messages 113-1-1 to 113-1-k and a second plurality of messages 113-2-1 to 113-2-n, and a classified message store 172. In some implementations, the categorization system 106 invokes the first classifier 170-1 to classify each message in the first plurality of messages 113-1-1 to 113-1-k thereby independently identifying an initial message category in a set of message categories for each respective message in the first plurality of messages.

An example of a set of message categories is {promotions, social, updates, forums, travel, finance, and receipts}. Each message category in the set of message categories requires that a message have certain characteristics. A message containing a reservation is classified as an “update” message in some embodiments. A message containing information about an event is classified as a “promotion” message in some embodiments. If a recipient is asked to rate something, the message is classified as a “social” message in some embodiments. In some embodiments, there is any number of additional messages categories in the set of message categories.

By way of nonlimiting example, in some embodiments, messages that are likely to be categorized as “promotions” are newsletters, offers and other bulk messages. In some embodiments, messages that likely to be categorized as “social” are messages originating from social networking website. In some embodiments, messages that likely to be categorized as “updates” are confirmations, bills, and receipt messages. In some embodiments, messages that are likely to be categorized as “forum” messages are messages from online groups, discussion boards, and mailing lists. In some embodiments, messages that likely to be categorized as “primary” are messages that do not fall into any of the other categories.

Categorization system 106 also invokes the second classifier 170-2 to classify each message in the second plurality of messages 113-2-1 to 113-2-k thereby independently identifying an initial message category in the same set of message categories for each respective message in the second plurality of messages. Once classified, messages in the first and second plurality of messages are stored in classified message store 172. In some embodiments, classified message store 172 includes only a reference to where such messages are stored (e.g., a reference to message queue or some other location where the message is stored) and the classification of the message. Referring to FIG. 3, messages in message store 172 are distributed to the devices 102 associated with the recipients of these messages by categorization system 106. For instance, in some embodiments network communication module 312 performs this function. In other embodiments, a dedicated mail sender module running on the categorization system 106 performs this function. In still other embodiments, one or more message transfer agents perform this distribution function.

As will be disclosed in further detail below, the first and second plurality of messages is processed in the manner described above in order to form message statistics for a first subset of messages in the first plurality of messages that are associated with a particular message reputation carrier and classified by the first classifier 170-1 and for a second subset of messages in the second plurality of messages that are associated with the same reputation carrier and that are processed by the second classifier 170-2. As disclosed in further detail below, the first and second classifier can be the same in some embodiments, but differ on some form of outside condition. For instance, in some embodiments the first classifier uses different thresholds or weights, or some messages are whitelisted to specific categories during operation of the first classifier but not the second classifier or vice versa. Moreover, the use of first and second classifiers 170 is by way of illustration only. In some embodiments, three classifiers are used to respectively classify three subsets of messages, all associated with the same message reputation carrier (e.g., all from the same sender), from three pluralities of messages. In a similar manner, four or more classifiers is used in some embodiments to categorize messages.

In some implementations, the message queue 112 stores electronic messages awaiting analysis by the first classifier, such as MSG 1-1, MSG 1-2, MSG 1-3 . . . and MSG 1-k (FIG. 1, 113-1-1 . . . 113-1-k). In some implementations, the message queue 112 also stores electronic messages awaiting analysis by the second classifier such as MSG 2-1, MSG 2-2, MSG 2-3, . . . and MSG 1-n (FIG. 1, 113-2-1 . . . 113-2-k). In some implementations, the message queue 112 includes different types of electronic messages, such as a file transfer 111-a (e.g., a photo, document, or video upload), an email 111-b, an instant message 111-c, a fax message 111-d, a social network update 111-e, a voice message 111-f, contact information, an indication of a document, a calendar entry, an email label, a recent search query, a suggested search query, or a web search result.

In some embodiments, the first classifier 170-1 and the second classifier 170-2 are each single classifiers that process messages during disjoint time intervals. In one such example, the first classifier 170-1 is used to classify messages in the message queue during time period [tᵢ, . . . , t₂] and the second classifier 170-2 is used to classify messages in the message queue during time period [t₃, . . . , t₄] with t₂<t₃. In such embodiments, there is exactly one classifier operating and exactly one message queue present in the system at any point in time. In some embodiments, both the first classifier 170-1 and the second classifier 170-2 evolve during their respective time intervals. In other words, in such embodiments, the weights or other parameters of classifier 170-1 and 170-2 evolve (e.g., weights or other parameters associated with such classifiers will change, for instance through refinement) while they are processing messages.

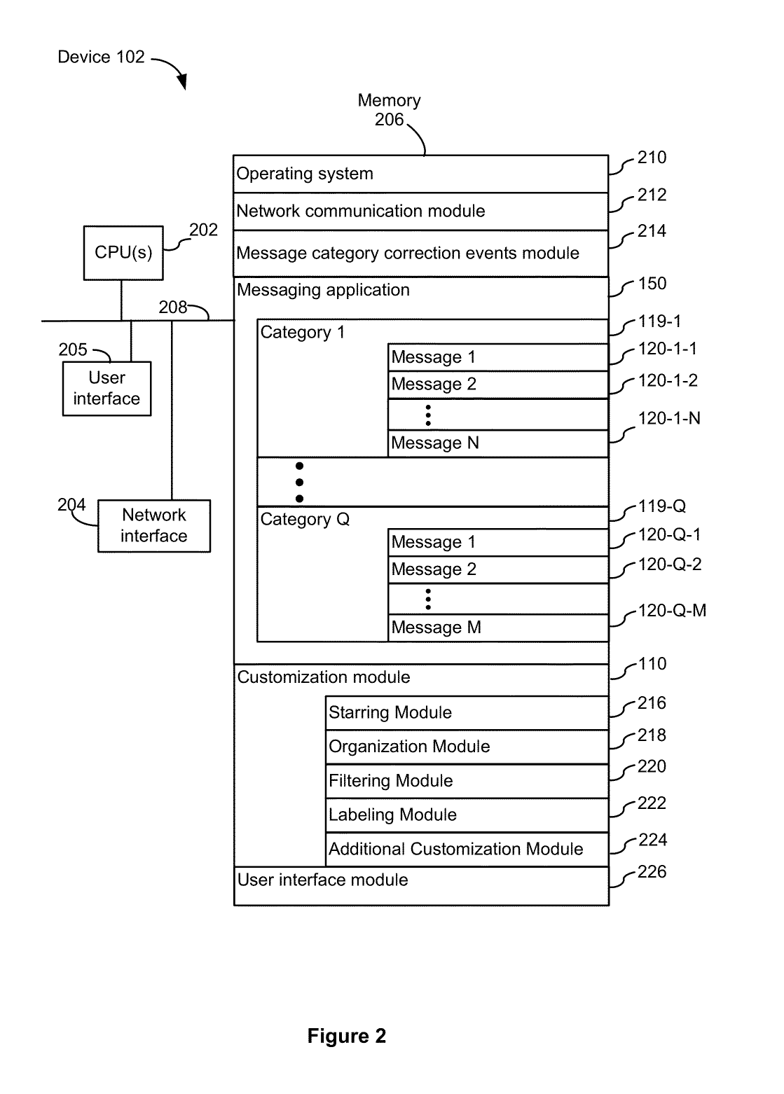

FIG. 2 is a block diagram illustrating a computing device 102, in accordance with some implementations. The device 102 in some implementations includes one or more processing units CPU(s) 202 (also referred to as processors), one or more network interfaces 204, a user interface 205, a memory 206, and one or more communication buses 208 for interconnecting these components. The communication buses 208 optionally include circuitry (sometimes called a chipset) that interconnects and controls communications between system components. The memory 206 typically includes high-speed random access memory, such as DRAM, SRAM, DDR RAM, ROM, EEPROM, flash memory, CD-ROM, digital versatile disks (DVD) or other optical storage, magnetic cassettes, magnetic tape, magnetic disk storage or other magnetic storage devices, other random access solid state memory devices, or any other medium which can be used to store desired information; and optionally includes non-volatile memory, such as one or more magnetic disk storage devices, optical disk storage devices, flash memory devices, or other non-volatile solid state storage devices. The memory 206 optionally includes one or more storage devices remotely located from the CPU(s) 202. The memory 206, or alternatively the non-volatile memory device(s) within the memory 206, comprises a non-transitory computer readable storage medium. In some implementations, the memory 206 or alternatively the non-transitory computer readable storage medium stores the following programs, modules and data structures, or a subset thereof:
an operating system 210, which includes procedures for handling various basic system services and for performing hardware dependent tasks;
a network communication module (or instructions) 212 for connecting the device 102 with other devices (e.g., the categorization system 106 and the devices 102B . . . 102N) via one or more network interfaces 204 (wired or wireless), or the communication network 104 (FIG. 1);
a messaging application 150 for processing and displaying incoming and outgoing electronic messages, including messages 120-1-1 through 120-1-N of category 119-1, . . . , messages 120-Q-1 through 120-Q-N of category 119-Q, where 1, 2, . . . , Q, are the message categories in a set of message categories; and
a customization module 110.

In some embodiments, the customization module 110 includes one or more of the following: a starring module 216 to allow a user to star a message for inclusion in a priority category; an organization module 218 to allow a user to move a message from one category to another (e.g., by dragging dropping); a filtering module 220 for allowing a user to specify a category rule for a message, and a labeling module 222 allowing a user to customize clusters for messages (by removing system created categories and/or creating additional categories.) Furthermore, the customization module 118 optionally includes one or more additional customization modules 224 for providing further user customization of categorization rules.

In some implementations, the user interface 205 includes an input device (e.g., a keyboard, a mouse, a touchpad, a track pad, and a touch screen) for a user to interact with the device 102.

In some implementations, the labeling module 222 labels an electronic message using a flag in accordance with which category the electronic message has been assigned. For example, after an email is assigned to both a “Travel” category and a “Promotion” category, the labeling module 222 assigns both the label “Travel” and the label “Promotion” to the electronic message. These approaches are advantageous, because message labels may simplify searches and selective retrievals of electronic messages, e.g., electronic messages may be searched, and retrieved, both using labels.

In some implementations, one or more of the above identified elements are stored in one or more of the previously mentioned memory devices, and correspond to a set of instructions for performing a function described above. The above identified modules or programs (e.g., sets of instructions) need not be implemented as separate software programs, procedures or modules, and thus various subsets of these modules may be combined or otherwise re-arranged in various implementations. In some implementations, the memory 206 optionally stores a subset of the modules and data structures identified above. Furthermore, the memory 206 may store additional modules and data structures not described above. In some embodiments, the device 102 is a thin client which does not include one or more of the customization modules 118 (e.g., the starring module 216; organization module 218; filtering module 220; labeling module 222, etc), and as such categorization customization is performed in part or in whole on the server categorization system 106.

FIG. 3 is a block diagram illustrating a categorization system 106, in accordance with some implementations. The categorization system 106 typically includes one or more processing units CPU(s) 302 (also referred to as processors), one or more network interfaces 304, memory 306, and one or more communication buses 308 for interconnecting these components. The communication buses 308 optionally include circuitry (sometimes called a chipset) that interconnects and controls communications between system components. The memory 306 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. The memory 306 optionally includes one or more storage devices remotely located from CPU(s) 302. The memory 306, or alternatively the non-volatile memory device(s) within the memory 306, comprises a non-transitory computer readable storage medium. In some implementations, the memory 306 or alternatively the non-transitory computer readable storage medium stores the following programs, modules and data structures, or a subset thereof:
an operating system 310, which includes procedures for handling various basic system services and for performing hardware dependent tasks;
a network communication module (or instructions) 312 for connecting the categorization system 106 with other devices (e.g., the devices 102) via the one or more network interfaces 304 (wired or wireless), or the communication network 104 (FIG. 1);
a first classifier 170-1 for conducting an analysis of a first plurality of electronic messages thereby independently identifying an initial message category in a set of message categories for each respective message in the first plurality of messages;
a second classifier 170-2 for conducting an analysis of a second plurality of electronic messages thereby independently identifying an initial message category in the set of message categories for each respective message in the second plurality of messages;
an optional customization module 118 for allowing a user to create and/or edit categorization rules in accordance with various categorization actions;
a message feedback module 325 for delivering the first and second plurality of messages to a plurality of recipients 102 with a designation of the message category of each respective message in the first and second plurality of messages, as respectively determined by the first 170-1 and second 170-2 classifier, collecting a plurality of recipient initiated message category correction events for messages in the first and second plurality of messages from the plurality of recipients 102, determining a correction weight for each respective correction type associated with the set of message categories using at least (i) the initial message category for each respective message in the first plurality of messages assigned by the first classifier, (ii) the initial message category for each respective message in the second plurality of messages assigned by the second classifier, and (iii) the plurality of recipient initiated message category correction events, using a correction weight for a correction type associated with the set of message categories to determine a probability or likelihood that a first message reputation carrier is associated with the first message category in the set of message categories and, optionally, whitelisting the first message reputation carrier to the first message category when the calculated probability or likelihood satisfies a whitelisting criterion;
a message queue 112 for storing electronic messages awaiting processing by the first classifier 170-1 or the second classifier 170-1, e.g., MSG 1-1, MSG 1-2, MSG 1-3, . . . and MSG 1-k (113-1-1, . . . , 113-1-k) for processing by the first classifier 170-1 and e.g., MSG 2-1, MSG 2-2, MSG 2-3, . . . and MSG 1-n (113-2-1, . . . , 113-2-n) for processing by the second first classifier 170-2; and
a classified message store 172, which includes a message category 180 in the set of message categories for each respective message analyzed by the first 170-1 or second 170-2 classifier as well as either the respective message or a link to the respective message.

In some embodiments, the customization module 118 includes one or more of the following: a starring module 316 to allow a user to star a message for inclusion in a priority category; an organization module 318 to allow a user to move a message from one category to another (e.g., by dragging dropping), a filtering module 320 for allowing a user to specify a category rule for a message, and a labeling module 322 allowing a user to customize categories for message (by removing system created categories and/or creating additional categories.) Furthermore, the customization module 118 optionally includes one or more additional customization modules 324 for providing further user customization.

In some implementations, one or more of the above identified elements are stored in one or more of the previously mentioned memory devices, and correspond to a set of instructions for performing a function described above. The above identified modules or programs (e.g., sets of instructions) need not be implemented as separate software programs, procedures or modules, and thus various subsets of these modules may be combined or otherwise re-arranged in various implementations. In some implementations, the memory 306 optionally stores a subset of the modules and data structures identified above. Furthermore, the memory 306 may store additional modules and data structures not described above.

Although FIGS. 2 and 3 show a “device 102” and a “categorization system 106,” respectively, FIGS. 2 and 3 are intended more as functional description of the various features which may be present in computer systems than as a structural schematic of the implementations described herein. In practice, and as recognized by those of ordinary skill in the art, items shown separately could be combined and some items could be separated.

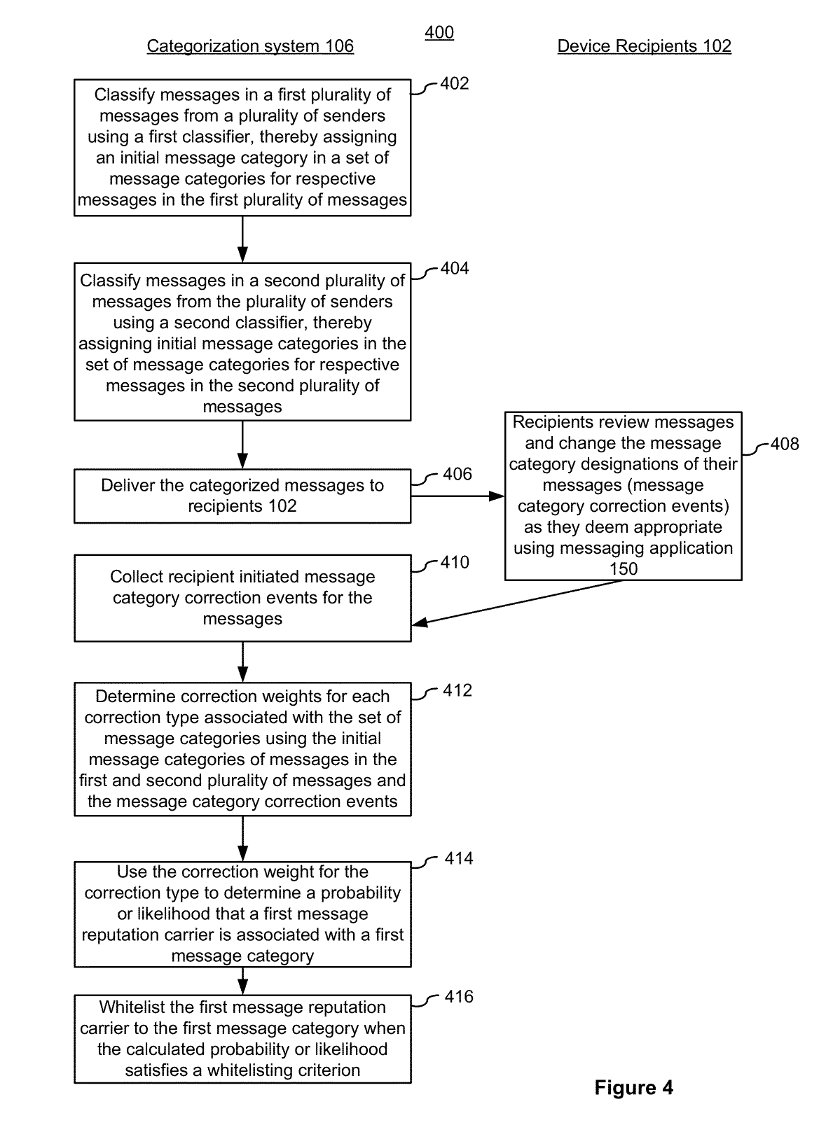

FIG. 4 is a flow chart illustrating a method for whitelising a first message reputation carrier to a first message category in a computing system in accordance with some implementations. As such, FIG. 4 addresses a reputation scoring problem. The goal of reputation scoring is to determine whether a given message reputation carrier (e.g., message sender) is predominantly associated with a single message category (e.g. promotional) and thus can be whitelisted accordingly. Such analysis attempts to capture the users' opinion about messages associated with a particular message reputation carrier. For example, if most users agree that some sender is promotional, the categorization accuracy can be improved by whitelisting that sender as promotional. Then, the reputation of a sender (reputation of a message reputation carrier) is estimated from aggregated user feedback.

The estimation of message reputation of a message reputation carrier is complicated by the fact that most users don't correct the automatically assigned category of messages associated with a given message reputation carrier even if they disagree with the category assignments. Unfortunately, raw recipient message category correction counts (correction events) are an unsatisfactory proxy for recipient opinion: most recipients do not correct message category assignments, even if they don't agree with them.

In order to relate the observed corrections to the recipient judgments, it is assumed that each recipient in a plurality of recipients has an opinion about which message category a message belongs. Further, if the user doesn't agree with the message category assigned by a classifier, it is assumed that the recipient corrects it with a given probability.

In accordance with the disclosed method, messages in a first plurality of messages encompassing a plurality of message reputation carriers (where each message in the first plurality of messages is associated with a single message reputation carrier in the plurality of message reputation carriers and the first plurality of messages represents the full plurality of message reputation carriers) are classified using a first classifier, thereby assigning an initial message category in a set of message categories for respective messages in the first plurality of messages (402). The plurality of message reputation carriers includes the first message reputation carrier under study. In some embodiments, the first classifier is a single classifier.

Further, messages in a second plurality of messages are classified using a second classifier, thereby assigning initial message categories in the set of message categories for respective messages in the second plurality of messages (404). Aggregated categorization statistics for messages for a first subset of messages in the first plurality of messages are compared with aggregated categorization statistics for a second subset of messages in the second plurality of messages, where all messages in the first and second subsets are associated with the same message reputation carrier.

In some embodiments, the first classifier and/or the second classifier classified messages into the set of message categories using any of a number of possible techniques. In one example, a classifier (e.g., first classifier 170-1 and/or second classifier 170-2 of FIGS. 1 and 3) examines the contents of messages. If the message contains words or phrases that are usually associated with a particular category in the set of categories, the message classifier classifies the message in that particular category. In another example, a message classifier compares the contents of a message to be classified to previously classified emails. If the unclassified message is similar to one or more previously sent messages, the message classifier classifies the message in the same category as the previously sent messages.

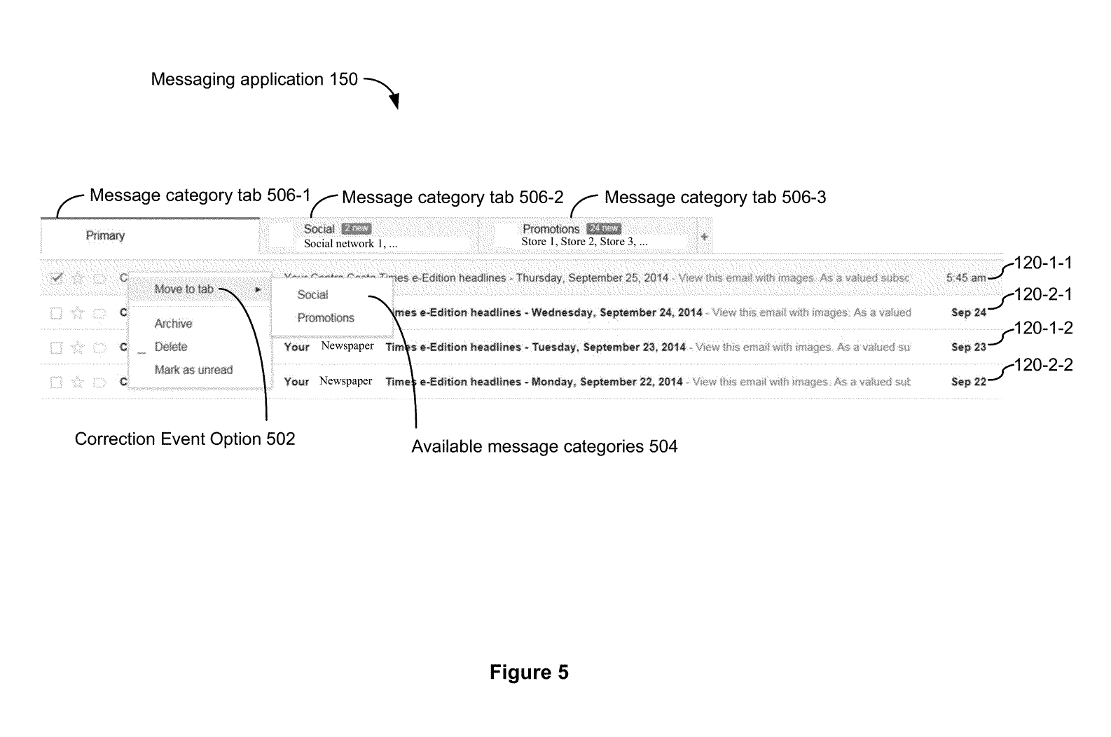

The categorized messages are delivered to recipients 102 (406). Recipients review the categorized messages and change the message category designations of their messages (message category correction events) as they deem appropriate using messaging application 150 (408). FIG. 5 illustrates a portion of the interface of an exemplary messaging application 150 running on a user device 102. The exemplary messaging application receives the first and second plurality of messages and arranges the messages into the tabs 506 that correspond to message categories. For example, those messages in the first and second plurality of messages that have been classified as “primary” by the first or second classifier are placed in message category tab 506, those messages in the first and second plurality of messages that have been classified as “primary” are placed in message category tab 506-1, those messages in the first and second plurality of messages that have been classified as “social” by the first or second classifier are placed in message category tab 506-2, and those messages in the first and second plurality of messages that have been classified as “promotions” are placed in message category tab 506-3. In FIG. 5, tab 506-1 is featured, meaning that the messages 120 in the category represented by tab 506-1 (primary) are listed in a specified order. In the example illustrated in FIG. 5, this order is chronological, but other ordering is available and/or possible.

FIG. 5 further illustrates how a recipient can initiate a message category correction event. The user selects a listed message (e.g., message 120-1-1), for example by right-clicking on the message with a mouse, thereby bringing up a menu that includes correction event option 502. By selecting correction event option 502, the user can change the category of the message to any of the other message category in a set of message categories using selection panel 504 (available message categories). In some embodiments, the set of message categories is promotions, social, updates, and forums. In some embodiments, the set of message categories is primary, promotions, social, updates, and forums.

Returning to FIG. 4, in the disclosed methods, such recipient initiated message category correction events for the messages are collected (410). As the foregoing shows, a message 120 is automatically assigned a category (the category predicted by the first or second classifier) and, upon delivery to client device 102, the message recipient may or may not correct this category. The delivery and correction events associated with a particular message reputation carrier (e.g., first sender, the sender whose message reputation is being assessed) are aggregated over an interval of time. In some embodiments, the resulting counts for the messages from this single message reputation carrier in the plurality of message reputation carriers is represented as a confusion matrix M=(c₁₁, c₁₂, . . . , cₙₙ), also termed an “observation” for the single message reputation carrier. A diagonal cell cᵢᵢ indicates how often a message was assigned by the first or second classifier into message category i without being corrected by the recipient. An off-diagonal cell cᵢⱼ, i≠j indicates how often a message was assigned message category i by the first or second classifier and later corrected to category j by the recipient. The total number of delivered messages (the sum of all matrix cells) associated with a first message reputation carrier in the plurality of message reputation carriers is denoted N.

In accordance with some embodiments of the present disclosure, the above identified information is considered data for a model that comprises two parameters. First, the probability that a message associated with a first message reputation carrier is categorized (by the first or second message classifiers) as message category i but is then judged by the message recipient to be of category j is pᵢⱼ. Second, given a message which was automatically categorized (by the first or second message classifiers) as category i and judged to be of category j by the message recipient, the message category is corrected with probability qᵢⱼ, i≠j. It is assumed that the qᵢⱼ do not depend on the identity of the message reputation carrier in the plurality of message reputation carriers.

The observed confusion matrix counts cᵢⱼ is expressed as follows:

pᵢⱼ·qᵢⱼ=cᵢⱼ/N for i≠j (1)

pᵢᵢ+Σ_{j≠i}pᵢⱼ·(1−qᵢⱼ)=cᵢᵢ/N (2)

Equation (1) can be rewritten as pᵢⱼ=(cᵢⱼ·wᵢⱼ)/N, where wᵢⱼ=qᵢⱼ⁻¹. The correction weight wᵢⱼ can be interpreted as an amplification factor which scales the observed correction count to the actual number of recipient disagreements for the received messages.

As noted above, the goal is to decide whether a first message reputation carrier should be whitelisted for a single message category or not. This involves determining how many messages associated with the first message reputation carrier are associated with each possible message category in the allowed set of message categories. To arrive at such information, consider the random variable C as the true category of a random message, drawn uniformly from all messages associated with the first message reputation carrier (e.g., dispatched by a given sender, where the sender is deemed in this example to be the first message reputation carrier). Here, the “true category” is the message's category according to the judgment of the recipient. The probability of drawing a message whose true category is k can be expressed as follows:

$$\begin{matrix}P ( C = k ) = {\sum }_{i} {p}_{ik} \\ = {p}_{kk} + {\sum }_{i \neq k} {p}_{ik} \\ = ( {c}_{kk} / N - {\sum }_{j \neq k} {p}_{kj} \cdot ( 1 - {q}_{kj} ) ) + {\sum }_{i \neq k} {c}_{ik} / N \cdot {q}_{ik}^{- 1} \\ = {c}_{kk} / N - {\sum }_{j \neq k} ( \frac{{c}_{kj}}{N} \cdot {q}_{kj}^{- 1} ) \cdot ( 1 - {q}_{kj} ) + {\sum }_{i \neq k} {c}_{ik} / N \cdot {q}_{ik}^{- 1} \\ = ( {c}_{kk} - {\sum }_{j \neq k} ( {c}_{kj} \cdot {q}_{kj}^{- 1} ) + {\sum }_{j \neq k} {c}_{kj} + {\sum }_{i \neq k} {c}_{ik} \cdot {q}_{ik}^{- 1} ) / N \\ = ( {\sum }_{i \neq k} ( {c}_{ik} \cdot {q}_{ik}^{- 1} ) - {\sum }_{j \neq k} {c}_{kj} \cdot {q}_{kj}^{- 1} + {\sum }_{j} {c}_{kj} ) / N\end{matrix}$$

The final equation shows that the number of messages originally categorized as category k is adjusted by adding the scaled number of corrections k into category k and subtracting the scaled number of corrections out of category k. Dividing by the total number of messages turns the adjusted “category count” into a probability. The purpose of the correction scaling is to compensate for the users' reluctance to correct.

The disclosed systems and methods provide ways to estimate the correction weights wᵢⱼ=qᵢⱼ⁻¹ in a data driven way using aggregated paired observations, e.g. two confusion matrices cᵢⱼ and c′ᵢⱼ associated with the same message reputation carrier (e.g., from the same sender). The two matrices represent different states of the same classifier, or two distinctly different classifiers. Thus, for instance, one matrix represents the messages in the first plurality of messages associated with the first reputation carrier (e.g., from the first sender) that have been initially classified by the first classifier whereas the other matrix represents the messages in the second plurality of messages associated with the first reputation carrier (e.g., from the first sender) that have been initially classified by the second classifier. In some embodiments the first classifier consists of a single first classifier and the second classifier consists of a single second classifier. In some such embodiments the first and second classifier are the same classifier. In some such embodiments, the first plurality of messages is processed (categorized) by the classifier under a first set of classifier parameters (such as machine learning thresholds) and the second plurality of messages is processed by the classifier under a second set of classifier parameters. Regardless whether the first and second classifiers are the same or different, their purpose in some embodiments is to assign categories to respective messages in a different way. One possibility is to choose a first message reputation carrier which was whitelisted at some point in time. Then cᵢⱼ (messages categorized by the first classifier) can be aggregated over an interval before whitelisting and c′ᵢⱼ aggregated over an interval after whitelisting. In such a scenario, there are two different sets of user reactions for the same mix of messages (assuming that the first message reputation carrier did not change its behavior across the messages associated with the first message reputation carrier in the first and second plurality of messages). For the single message reputation carrier, this can be formalized as an equation system:

$$\begin{matrix}{p}_{ij} - {w}_{ij} \cdot \frac{{c}_{ij}}{N} = 0 for i \neq j & ( 3 ) \\ {\sum }_{j} {p}_{ij} - {\sum }_{j} \frac{{c}_{ij}}{N} = 0 for all i & ( 4 ) \\ {p}_{ij}^{′} - {w}_{ij} \cdot {c}_{ij}^{′} / {N}^{′} = 0 for all i \neq j & ( 5 ) \\ {\sum }_{j} {p}_{ij}^{′} - {\sum }_{j} {c}_{ij}^{′} / {N}^{′} = 0 for all i & ( 6 ) \\ {\sum }_{i} {p}_{ij} - {\sum }_{i} {p}_{ij}^{′} = 0 for all j & ( 7 )\end{matrix}$$

Equations (3) and (5) correspond to equation (1) applied to the first and the second observation, respectively. Equations (4) and (6) ensure that the marginal distributions of the pᵢⱼ match those of the cᵢⱼ/N and thus implicitly constrain the pᵢᵢ as is done explicitly in equation (2). As stated above, it is assumed that the first message reputation carrier did not change its behavior and dispatched the same mix of messages for both observations. Thus, it can be expected that the same fraction of messages is judged to be associated with each category j. This assumption is formalized in equation (7).

Assuming that there are M categories in the set of possible message categories, the above equation system has 2M²+M equations and 3M²−M variables (pᵢⱼ,p′ᵢⱼ, wᵢⱼ) (since wᵢⱼ is only defined for i≠j) and is therefore underdetermined. However, it is possible to combine the equations of many message reputation carriers (e.g., many senders). Since the correction weights wᵢⱼ are shared by all message reputation carriers, this represents an overdetermined equation system for which an optimal solution can be found by means of least squares optimization. To combine the information of K message reputation carriers (e.g., a plurality of senders), the above equations can be modified as follows:

$$\begin{matrix}{p}_{i , j , m} - {w}_{ij} \cdot \frac{{c}_{ij , m}}{{N}_{m}} = 0 for i \neq j , 0 \leq m < 2 K & ( 8 ) \\ {\sum }_{j} {p}_{i , j , m} - {\sum }_{j} {c}_{i , j , m} / {N}_{m} = 0 for all i , 0 \leq m < 2 K & ( 9 ) \\ {\sum }_{i} {p}_{i , j , 2 k} - {\sum }_{i} {p}_{i , j , 2 k + 1} = 0 for all j , 0 \leq k < K & ( 10 )\end{matrix}$$

Here, the third index ofp and c identifies an observation (a confusion matrix). The observations 2k and 2k+1 belong to (are associated with) the same message reputation carrier k, 0≦k<K in the plurality of message reputation carriers. Equation 10 demonstrates the basis for using a first plurality of messages and a second plurality of messages, where aggregated categorization statistics for a first subset of messages in the first plurality of messages are compared with aggregated categorization statistics for a second subset of messages from the second plurality of messages where all messages in the first subset of messages and the second subset of message messages are associated with the same message reputation carrier (e.g., from the same sender). In some instances, messages in the first and second message subsets are identical except that they are addressed to different recipients.

Returning to FIG. 4, the disclosed methods continue with a determination of correction weights for each correction type associated with the set of message categories using the initial message categories of messages in the first and second plurality of messages and the message category correction events (412). As specified before, in some embodiments, the set of message categories consists of promotions, social, updates, forums, travel, finance, and receipts. In some embodiments, the set of message categories consists of primary, promotions, social, updates, forums, travel, finance, and receipts. In some embodiments, the set of message categories consists of promotions, social, updates, and forums. It will be appreciated that other sets of message categories are possible. In general, the set of message categories consists of the set of possible classification states of the first classifier and second classifier. For instance, if the first and second classifiers are capable of classifying messages into any one of W categories, where W is a positive integer of two or greater, than the set of message categories consist of W categories. For example, if W is three, the set of possible message categories is {A, B, C}, for which there are therefore six possible correction event types: {A→B, A→C, B→A, B→C, C→A, and C→B}, where the first type X in the category pair X→Y, is assigned by an automated classifier (either the first classifier or the second classifier) and the second type Y in the category pair is reassigned by the recipient. In this instance, step 412 involves the determination of correction weights for each of the six correction types.

If the first and second plurality of messages is populated by messages associated with a sufficiently large number of message reputation carriers (e.g., a first subset of messages associated with a first message reputation carrier, a second subset of messages associated with a second message reputation carrier, and so forth), it is possible to overdetermine the equation system, and therefore find an optimal or otherwise satisfactory set of variable assignments with respect to a suitable error function. Due to the model assumptions and the nature of the measurements made, the equation system does in general not have a direct solution. However, the model can be fitted to the data using a linear least squares approach. For example, a unique set of parameters which minimizes the quadratic error expressed by a loss function. One such example of a loss function is:

loss=Σ_{i,j≠i,m}(p_{i,j,m}−w_{i,j}·c_{i,j,m}/Nₘ)²+Σ_{i,m}(Σⱼp_{i,j,m}−c_{i,j,m}/Nₘ)²+Σ_{j,k}(Σᵢp_{i,j,2k}−p_{i,j,2k+1})²

For this loss function, m is in the range 0≦m<2K, where K is the number of message reputation carriers (e.g., senders) in the plurality of message reputation carriers. Also, observations 2k and 2k+1 are associated with the same message reputation carrier in the plurality of message reputation carriers, and k is in the range 0≦k<K, and i and j are the i^{th} and j^{th} message categories in the set of message categories. The symbol w_{i,j} is a respective correction weight associated with the set of message categories for correction between the i^{th} and j^{th} message categories in the set of message categories. The first or second classifier initially classifies a message as message category i and recipients in the plurality of recipients then classify the message as message category j. The expression p_{i,j,m} is the probability that recipients in the plurality of recipients will reclassify a message associated with observation m (e.g., confusion matrix of messages for a given message reputation carrier), which has initially been categorized by the first or second classifier as being in message category i, to category j. The expression c_{i,j,m} is the number of messages associated with observation m that recipients in the plurality of recipients change from the message category i, which was assigned by the first or second classifier, to the message category j. The expression Nₘ is the number of messages in the combination of the first plurality of messages and the second plurality of messages that are associated with observation m. The expression p_{i,j,2k} is the probability that recipients in the plurality of recipients will reclassify (correct) a message associated with message reputation carrier k, which has initially been categorized by the first classifier as being in message category i, to category j. The expression p_{i,j,2k+1} is the probability that recipients in the plurality of recipients will reclassify a message associated with message reputation carrier k, which has initially been categorized by the second classifier as being in message category i, to category j.

Several variants on the above-identified loss function are possible and all such variants are within the scope of the present disclosure. For example, in some embodiments correction weights are constrained to be equal. For example, in some embodiments the assumption is made that the correction weight does not depend on the original and the target category, e.g. that all wᵢⱼ are equal. Given that the postulated weight equalities are reasonable, such constraints can help to find better estimates when facing sparse data in some embodiments. In some embodiments, weight equality constraints are implemented by means of an indexing function ƒ(ij) which assigns a weight index to a category pair (i,j), i≠j. Using w_{f(i,j)} instead of w_{i,j} has the effect of forcing all corrections (i,j) with the same ƒ(i,j) to share a common weight parameter. In some embodiments, weight equality constraints are rigidly forced to have a common weight parameter, however, any differences in such weight parameters is penalized with a penalty term.

In yet another variant of the above-identified loss function parameter, large correction weights are penalized. This is a form of regularization. In one such regularization approach, squared parameter values are added to the loss function, balanced with a regularization constant λ. As a result, the optimal value of some correction weight wₖ can only be large if it can account for a large reduction of the loss function. This helps to avoid overfitting since an increase of a correction weight must reduce the error across many different message reputation carriers rather than a single message reputation carrier.

In some embodiments, the loss function that is solved includes the shared weight constraints and regularization described above has the form:

$$loss = {\sum }_{i , j \neq i , m} {( {p}_{i , j , m} - {w}_{f ( i , j )} \cdot {c}_{i , j , m} / {N}_{m} )}^{2} + {\sum }_{i , m} {( {\sum }_{j} {p}_{i , j , m} - {c}_{i , j , m} / {N}_{m} )}^{2} + {\sum }_{j , k} {( {\sum }_{i} {p}_{i , j , 2 k} - {p}_{i , j , 2 k + 1} )}^{2} + λ {\sum }_{i} {w}_{i}^{2} \qquad ( 11 )$$

where m is in the range 0≦m<2K, K is the number of message reputation carriers (e.g., senders) in the plurality of message reputation carriers, observations 2k and 2k+1 are associated with the same message reputation carrier in the plurality of message reputation carriers, and k is in the range 0≦k<K, i and j are the i^{th} and j^{th} message categories in the set of message categories, and w_{f(i,j)} is a respective correction weight associated with the set of message categories for correction between any first and second message categories in the set of message categories, where the first or second classifier initially classifies a message to the first message category and recipients in the plurality of recipients then classify the message to the second message category. The expressions p_{i,j,m}, c_{i,j,m}, Nₘ, p_{i,j,2k}, and p_{i,j,2k+1} are as defined above, λ is a constant, and wᵢ² is a weight constant for respective message category i. For completeness, the corresponding equations for this loss function are:

$$\begin{matrix}{p}_{i , j , m} - {w}_{f ( i , j )} \cdot \frac{{c}_{i , j , m}}{{N}_{m}} = 0 for i \neq j , 0 \leq m < 2 K & ( 12 ) \\ {\sum }_{j} {p}_{i , j , m} - {\sum }_{j} {c}_{i , j , m} / {N}_{m} = 0 for all i , 0 \leq m < 2 K & ( 13 ) \\ {\sum }_{i} {p}_{i , j , 2 k} - {\sum }_{i} {p}_{i , j , 2 k + 1} = 0 for all j , 0 \leq k < K & ( 14 )\end{matrix}$$

Now that exemplary loss functions in accordance with embodiments of the disclosure have been provided, attention now turns to how to minimize such loss functions. In some embodiments, a gradient function is used. As the loss function is convex, it has a single minimum which can be found by iteratively moving the current parameter vector in the direction of the negative gradient. In some embodiments, a limited memory Broyden-Fletcher-Goldfarb-Shanno (L-BFGS) optimizer, which is particularly suited for a large number of variables, is used. Similar to Newton's method, the L-BFGS algorithm uses the (approximate) second derivatives of the objective function (the loss function) to achieve fast convergence.

In some embodiments, the gradients of the loss function (11) with respect to each variable are shown in equations (15) through (19):

$$\begin{matrix}\frac{d}{d {p}_{i , j , m}} loss = 2 \cdot ( {p}_{i , j , m} - {w}_{f ( i , j )} \cdot \frac{{c}_{i , j , m}}{{N}_{m}} ) + 2 ( {\sum }_{k} {p}_{i , k , m} - {c}_{i , k , m} / {N}_{m} ) + 2 {\sum }_{k} ( - {p}_{k , j , m - 1} + {p}_{k , j , m} ) if i \neq j , odd ( m ) & ( 15 ) \\ \frac{d}{d {p}_{i , j , m}} loss = 2 \cdot ( {p}_{i , j , m} - {w}_{f ( i , j )} \cdot \frac{{c}_{i , j , m}}{{N}_{m}} ) + 2 {\sum }_{k} ( {p}_{i , k , m} - {c}_{i , k , m} / {N}_{m} ) + 2 {\sum }_{k} ( {p}_{k , j , m} - {p}_{k , j , m + 1} ) if i \neq j , even ( m ) & ( 16 ) \\ \frac{d}{d {p}_{i , i , m}} loss = 2 {\sum }_{k} ( {p}_{i , k , m} - {c}_{i , k , m} / {N}_{m} ) + 2 {\sum }_{k} ( - {p}_{k , i , m - 1} + {p}_{k , i , m} ) if odd ( m ) , & ( 17 ) \\ \frac{d}{d {p}_{i , i , m}} loss = 2 {\sum }_{k} ( {p}_{i , k , m} - {c}_{i , k , m} / {N}_{m} ) + 2 {\sum }_{K} ( {p}_{k , i , m -} - {p}_{k , i , m + 1} ) if even ( m ) , & ( 18 ) \\ \frac{d}{d {w}_{k}} loss = {\sum }_{m , i \neq j , f ( i , j ) = k} - 2 \cdot ( {p}_{i , j , m} - {w}_{k} \cdot {c}_{i , j , m} / {N}_{m} ) \cdot {c}_{i , j , m} / {N}_{m} + 2 \cdot λ \cdot {w}_{k} & ( 19 )\end{matrix}$$

The parity constraints for observation m stem from the fact that an even observation m and the following observation m+1 are from the same observation pair. In some embodiments, the regularization parameter λ is chosen manually. In some embodiments the gradient is numerically approximated rather than being computed analytically. This allows for elimination of equations (15) to (19) and thus simplifies the code for performing the computation, although not necessarily the amount of computation.

In some embodiments, the least-squares problem posed by the loss function is solved by solving normal equations. In some embodiments, the least-squares problem posed by the loss function is solved by solving normal equations with regularization.

In some embodiments, the least-squares problem posed by the loss function is minimized using a quasi-Newton method, such as the Broyden-Fletcher-Goldfarb-Shanno (BFGS) algorithm. In quasi-Newton methods, the Hessian matrix of second derivatives of the loss function need not be evaluated directly. Instead, the Hessian matrix is approximated using rank-one updates specified by gradient evaluations (or approximate gradient evaluations). Quasi-Newton methods are a generalization of the secant method to find the root of the first derivative for multidimensional problems. In multi-dimensions the secant equation does not specify a unique solution, and quasi-Newton methods differ in how they constrain the solution.

In some embodiments, the loss function is minimized using a random walk method, such as simulated annealing (“SA”), that does not require derivatives. In some embodiments, the loss function is minimized until an exit condition is achieved. In some instances, the exit condition is determined by the method by which the cost function is minimized. For example, Berinde, 1997, Novi SAD J. Math, 27, 19-26, which is incorporated herein by reference, outlines some exit conditions for Newton's method. In some embodiments, the exit condition is achieved when a predetermined maximum number of iterations of the refinement algorithm used to refine the cost function have been computed. In some embodiments, the predetermined maximum number of iterations is ten iterations, twenty iterations, one hundred iterations or one thousand iterations. In preferred embodiments, a gradient descent approach is used until a global minimum of the loss function is achieved, is used.

At this stage, by solving any of the above-identified loss functions using any of the above-identified methods, a correction weight is determined (e.g., estimated) for each respective correction type associated with the set of message categories under study. Returning to the flow chart of FIG. 4, such correction weights are then used to determine a probability or likelihood that a first message reputation carrier is associated with a first message category (414). In other words, if C is a random variable C designating the true category of a random message, drawn uniformly from all messages associated with the first message reputation carrier (e.g., dispatched by the first sender), the probability of drawing a message for that first message reputation carrier whose true category is the first message category k can be expressed as P (C=k). One equation for P (C=k) is

Σ_{i≠k}(cᵢₖ·qᵢₖ⁻¹)−Σ_{j≠k}cₖⱼ·qₖⱼ⁻¹+Σⱼcₖⱼ)/N (20)

Here, qᵢₖ⁻¹ is the correction weight for messages assigned by the first or second classifier to message category i that are then assigned by message recipients to message category k, i≠k, and i is a message category in the set of message categories. Also, qₖⱼ⁻¹ is a correction weight for messages assigned by the first or second classifier to message category k that are then assigned by message recipients to message category j, k≠j, and j is a message category in the set of message categories. The count cᵢₖ is a count of messages in the first and second plurality of messages that are assigned by the first or second classifier to message category i that are then assigned by message recipients to message category k. The count cₖⱼ is a count of messages in the first and second plurality of messages that are assigned by the first or second classifier to message category k that are then assigned by message recipients to message category j. Finally, N is the number of messages in the first and second plurality of messages that are associated with the first message reputation carrier (e.g., sent by the first sender).

In some embodiments, equation (20) is used to determine a probability or likelihood that the first message reputation carrier is associated with the first message category k by filling the values qᵢₖ⁻¹ and qₖⱼ⁻¹ that were solved in step 412 and observed counts cᵢₖ and cₖⱼ and the value N. Equation 20 can be solved for each possible message category in this fashion. From this, the probability or likelihood that the message reputation carriers is associated with any given category in the set of message categories (e.g., the first sender sends messages of any given category in the set of message categories) is computed. As an illustration, consider the case in which there are four message categories in the set of message categories {promotions, social, updates, and forums}. This is not to say recipients do not receive messages in a primary category as well, it is just that the message reputation carrier under study is a known commercial entity and the issue is whether messages from that entity are better categorized under promotions, social, updates, or forums for a plurality of users. In this example, Equation (20) is calculated for the message reputation carrier under study for each category (promotions, social, updates, forums) to arrive at four probability calculations, where each of the respective probability calculations is the probability that messages associated with the first message reputation carrier (e.g., from the first sender) are associated with a corresponding category in the set of categories (e.g., a first probability that the first message reputation carrier is associated with messages in the promotions category, a second probability that the first message reputation carrier is associated with messages in the social category, a third probability that the first message reputation carrier is associated with messages in the update category, and a fourth probability that the first message reputation carrier is associated with messages in the forums category).

At a minimum, stage 414 provides a calculated probability or likelihood that the first message reputation carrier is associated with a first message category in the set of message categories. In stage 416, this information is used to determine whether the calculated probability or likelihood is sufficient to satisfy a whitelisting criterion. Such whitelisting criterion are inherently application specific. For instance the whitelisting criterion may depend upon the number of message categories in the set of message categories. In one example, the more message categories that are in the set of message categories, the lower the calculated probability or likelihood can be in order to satisfy a whitelisting criterion. As a specific example, a set of message categories that consists of only two message categories may require a seventy percent likelihood that the first message reputation carrier is associated with messages in a first category in order to whitelist the first message reputation carrier to the first category whereas a set of message categories that consists of 10 message categories may only require a thirty percent likelihood or probability that the first message reputation carrier is associated with messages in the first message category. As another example of how the whitelisting criterion is necessarily application dependent, the whitelisting criterion may depend upon not only the calculated probability or likelihood that the first message reputation carrier is associated with messages in one category in the set of message categories, but also the calculated probability or likelihood that the first message reputation carrier is associated with messages in other categories in the set of message categories. For instance, if two of the message categories have very similar calculated probability or likelihoods and they represent the highest probability or likelihoods in the set of message categories, the whitelisting criterion may be deemed to not be satisfied even though the absolute number for the probability or likelihoods of one of the categories is above a threshold value. Consistent with the these examples, in some embodiments the whitelisting criterion is a threshold probability or likelihood, and the calculated probability or likelihood satisfies the whitelisting criterion when the calculated probability or likelihood is equal to or greater than the threshold probability or likelihood (e.g., a probability of thirty percent or more, forty percent or more, fifty percent or more, in various embodiments).

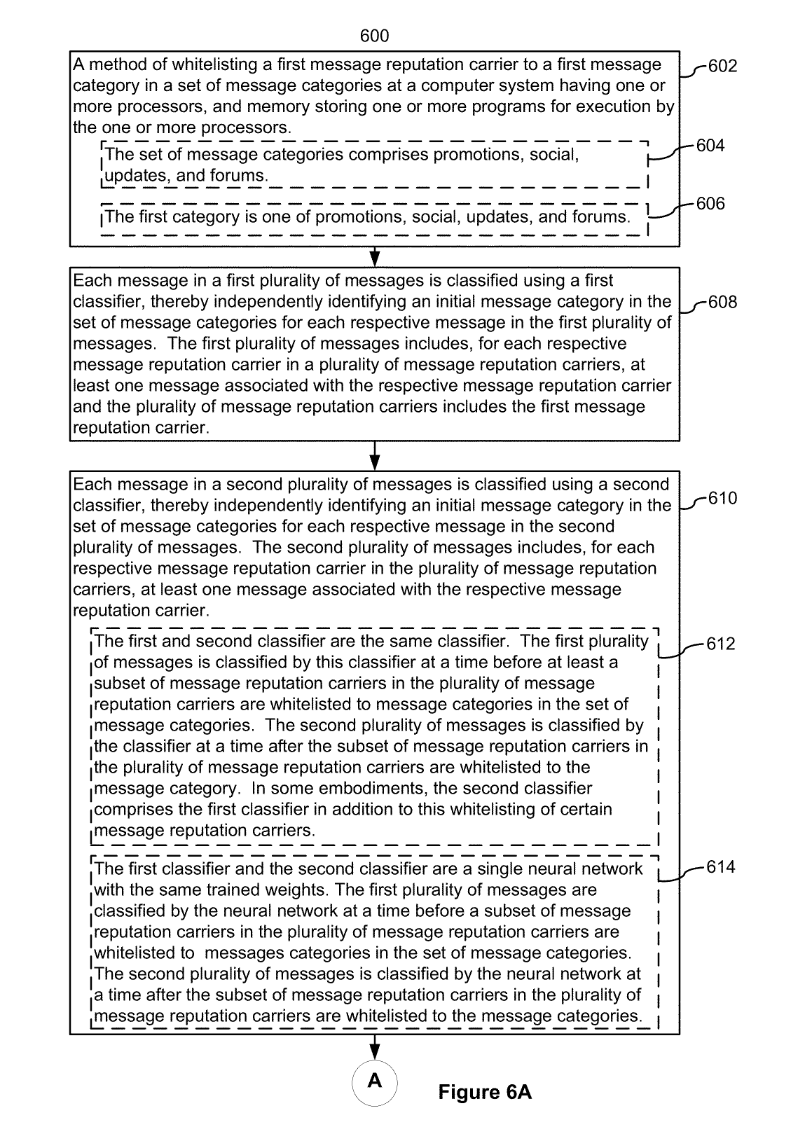

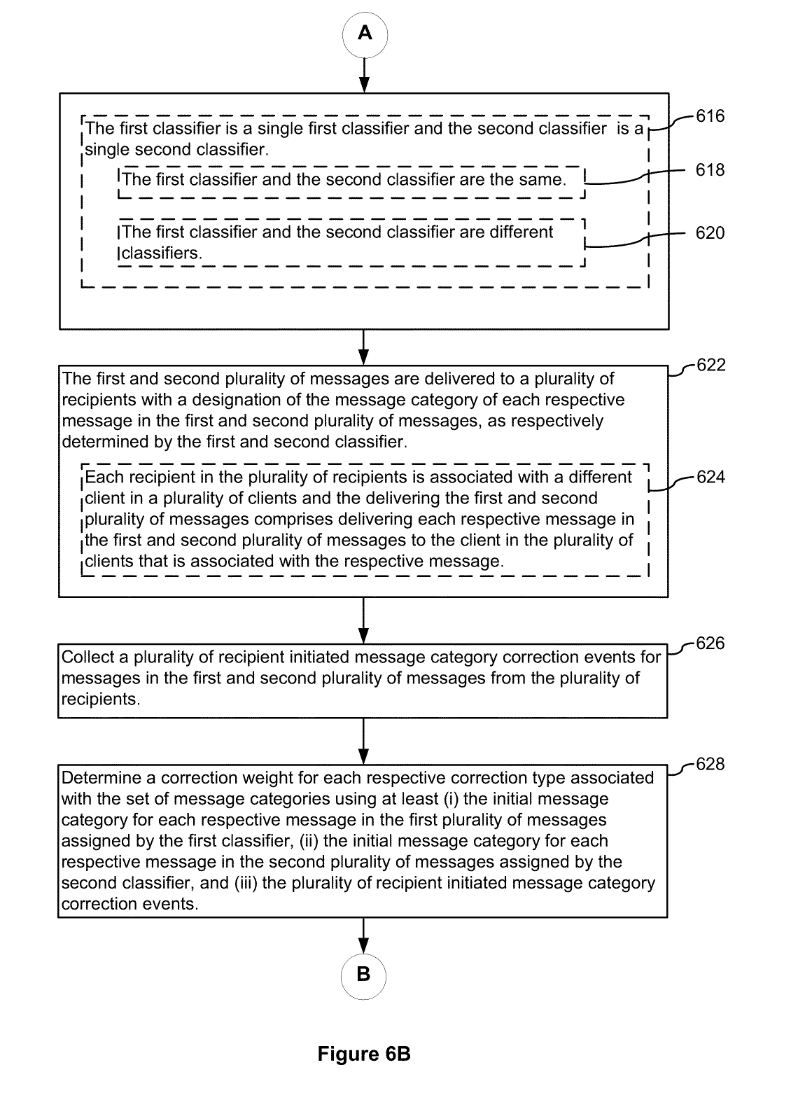

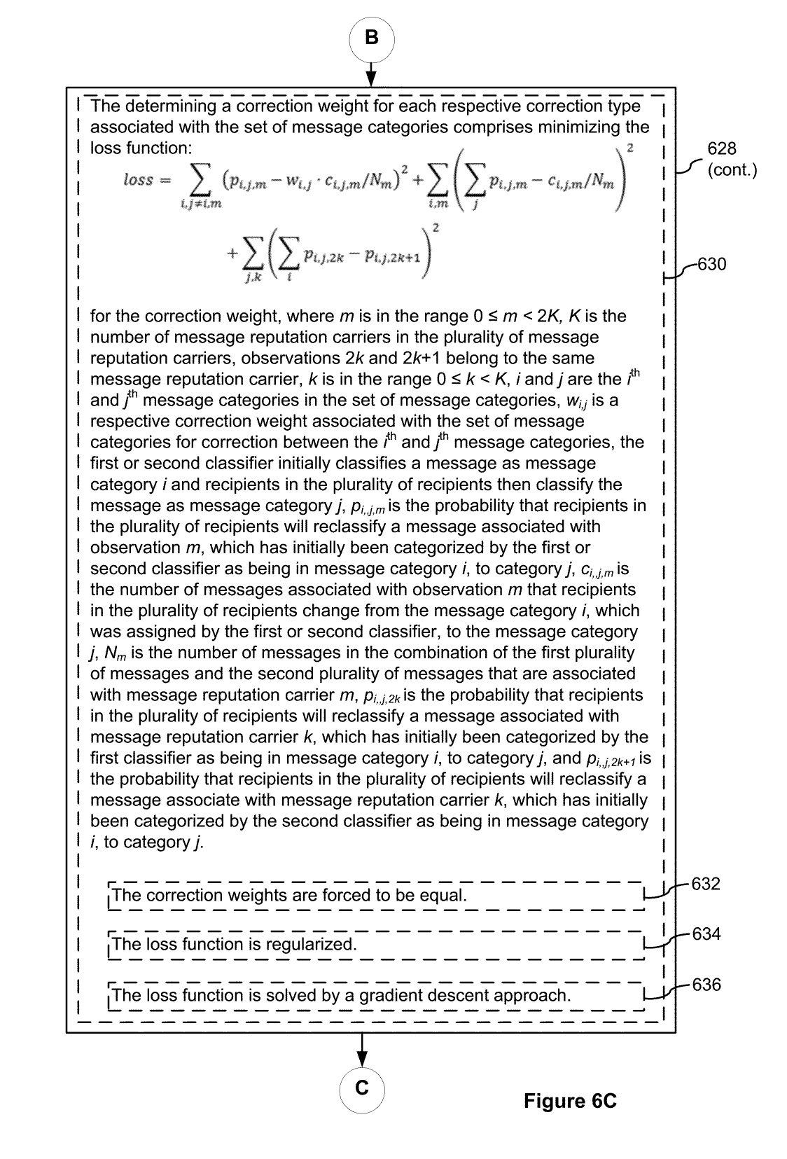

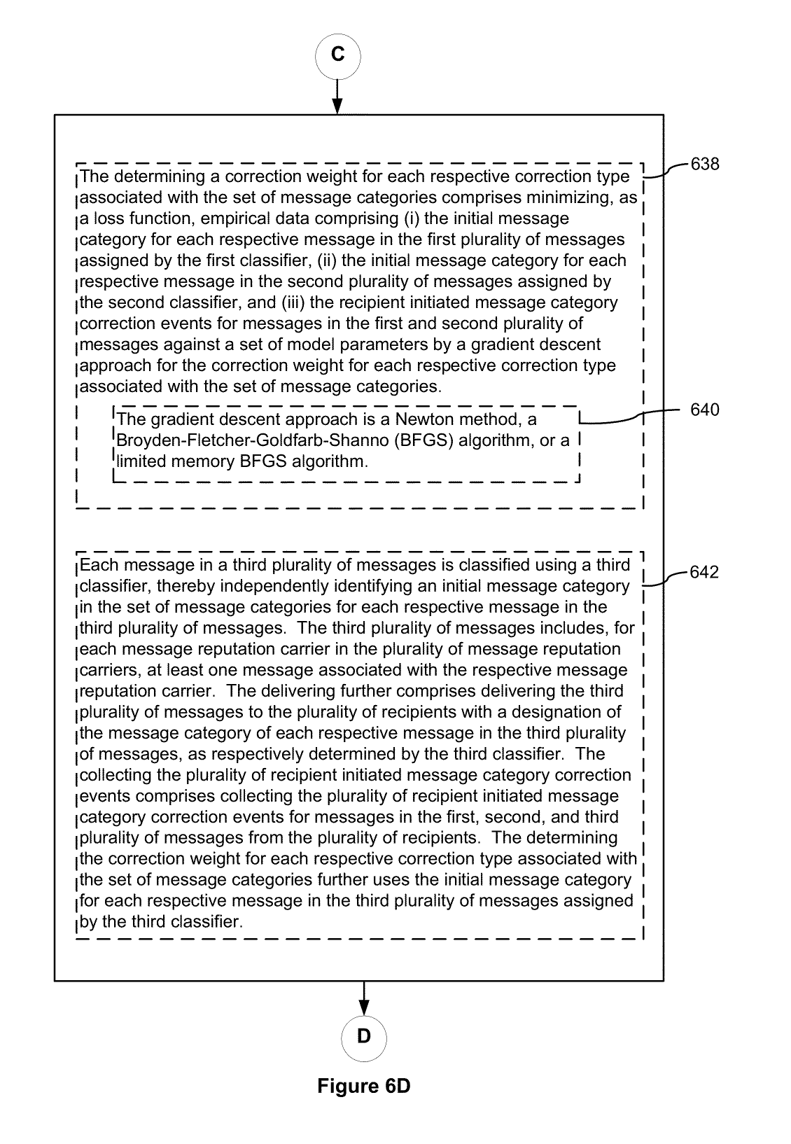

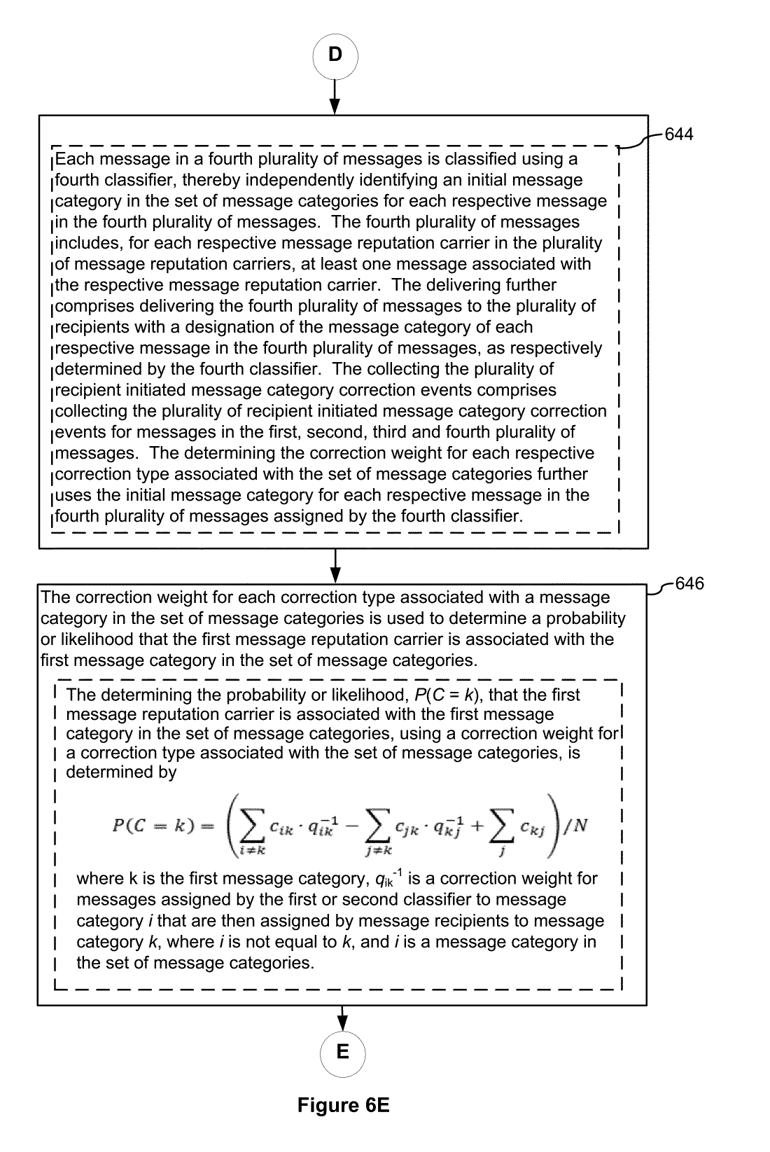

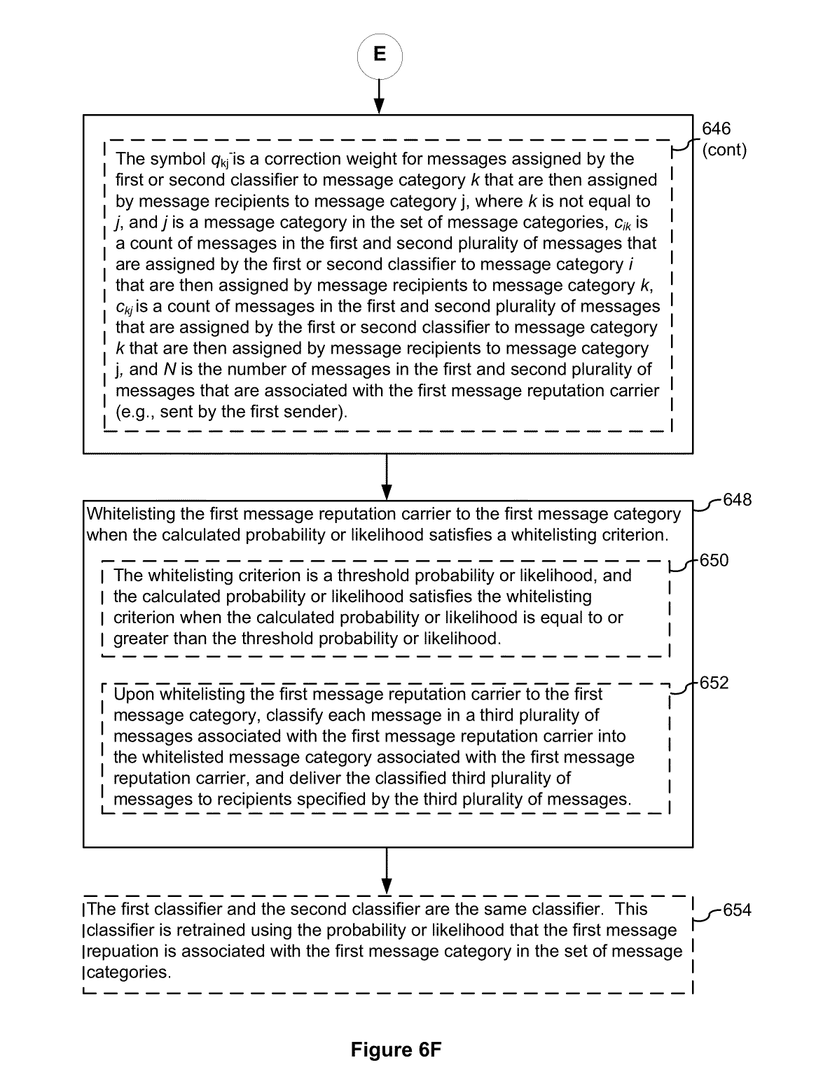

FIG. 6 illustrates a flow chart for method 600 of whitelisting a first message reputation carrier to a first message category in a set of message categories at a computer system having one or more processors, and memory storing one or more programs for execution by the one or more processors (602). An exemplary set of message categories comprises promotions, social, updates, and forums (604). However any discrete set of message categories is used in some embodiments. In the case where the exemplary set of message categories is promotions, social, updates, and forums, the first category (the category to which the first sender is to be whitelisted when certain conditions described below occur) is one of promotions, social, updates, and forums (606).

Turning to step 608, in accordance with the method, each message in a first plurality of messages is classified using a first classifier thereby independently identifying an initial message category in the set of message categories for each respective message in the first plurality of messages. For example, if the first plurality of messages is 10 messages and the set of message categories is {A, B, C}, step 608 assigns one of {A, B, C} to each of the 10 messages. The first plurality of messages includes at least one respective message associated with each message reputation carrier in a plurality of message reputation carriers and the plurality of message reputation carriers includes the first message reputation (608). Such requirements are to ensure that the first plurality of messages can be paired with messages (in the aggregate) in the second plurality of messages, and furthermore, to ensure that a set of equations representing user feedback can be overdetermined in order to accurately assess user feedback.

Turning to step 610, each message in a second plurality of messages is classified using a second classifier, thereby independently identifying an initial message category in the set of message categories for each respective message in the second plurality of messages. As was the case with the first plurality of messages, the second plurality of messages includes at least one respective message associated with each reputation carrier (e.g., from each sender) in the plurality of message reputation carriers (e.g., plurality of senders) (610). In some embodiments, the number of message reputation carriers in the plurality of message reputation carriers needed is somewhat dependent upon the number of possible message categories in the set of message categories.

In some embodiments, the first classifier and the second classifier are the same classifier. In some such embodiments, the first plurality of messages is classified by the classifier at a time before a subset of message reputation carriers in the plurality of message reputation carriers are whitelisted to a message category in the set of message categories while the second plurality of messages is classified by the classifier at a time after the subset of message reputation carriers in the plurality of message reputation carriers are whitelisted to the message category (612). To illustrate, consider a case in which the message reputation carrier is the identity of an individual message sender, and the first plurality of messages is 1000 senders and the subset of senders is 100 of these senders. In this illustration, the first plurality of messages is categorized by the classifier before 100 of the 1000 senders have been whitelisted, and the second plurality of messages is categorized by the classifier after the 100 senders have been whitelisted. The whitelisting of the 100 senders forces messages from these senders to be categorized into a hard coded whitelist category associated with each of the 100 senders, rather than be classified by some other rules of the classifier, such as rules that classify messages based on message content. In most instances, this will have some appreciable differential effect on the classification of messages between the first and second plurality of messages that can be exploited in order to more accurately assess user message category preferences for messages.

In a more specific embodiment, the first classifier and the second classifier are a single neural network with the same trained weights. In some such embodiments, the first plurality of messages are classified by the neural network at a time before a subset of message reputation carriers in the plurality of message reputation carriers are whitelisted to a message category in the set of message categories while the second plurality of messages are classified by the neural network at a time after the subset of message reputation carriers in the plurality of message reputation carriers are whitelisted to the message category (614). In alternative embodiments, the second classifier differs from the first classifier in that the second classifier includes whitelisted message reputation carriers in the plurality of message reputation carriers.

In some embodiments, the first classifier is a single first classifier and the second classifier is a single second classifier (616). In some such embodiments, the first and second classifier is the same classifier (618). In some such embodiments, the first and second classifier is the same classifier that classify messages in a message queue at disjoint (non-overlapping) time intervals. In some such embodiments, the first and second classifiers are different classifiers (620). Examples of classifiers are described in Duda, 2001, Pattern Classification, John Wiley & Sons, Inc., and Hastie et al., 2001, The Elements of Statistical Learning, Springer-Verlag, New York, each of which are hereby incorporated by reference. For instance, examples of classifiers that are used in some embodiments for the first and second classifiers include, but are not limited to, decision trees, multiple additive regression trees, neural networks, clustering, principal component analysis, nearest neighbor analysis, linear discriminant analysis, quadratic discriminant analysis, support vector machines, variants and derivatives thereof, all either alone or in any combination. Moreover, in some embodiments, the first classifier or the second classifier comprises a plurality of classifiers that have been combined using techniques such as bagging, boosting, a random subspace method, additive trees, Adaboost or other known combining techniques. See, for example, Breiman, 1996, Machine Learning 24, 123-140, and Efron and Tibshirani, “An Introduction to Boostrap,” Chapman & Hall, New York, 1993, which is hereby incorporated by reference in its entirety.

The method continues with the delivery of the first and second plurality of messages to a plurality of recipients with a designation of the message category of each respective message in the first and second plurality of messages, as respectively determined by the first and second classifier (622). In some embodiments, each recipient in the plurality of recipients is associated with a different client in a plurality of clients and the delivery of the first and second plurality of messages comprises delivering each respective message in the first and second plurality of messages to the client in the plurality of clients that is associated with the respective message (624). Recipients review the messages using a messaging application. An example of a partial user interface for a messaging application 150 is given in FIG. 5.

The method continues with the collection of a plurality of recipient initiated message category correction events for messages in the first and second plurality of messages (626). That is, any time a recipient changes the message category of a received message using, for example, the messaging application 150 on a device 102, this is collected as a recipient initiated message category correction event. In some embodiments, message correction events are aggregated into time windows of predetermined time duration. The predetermined time duration over which message category correction events are aggregated is application dependent and in fact, in some embodiments, many aggregation windows of different time durations are evaluated. In some embodiments, such aggregation windows are overlapping. In some embodiments, such aggregation windows are not overlapping. In some embodiments the duration of time of an aggregation window is a number of hours, a number of days or a number of weeks. In some embodiments it is continuous, which is to say that the method processes any events collected to date in accordance with the disclosed methods on a rolling basis, with new event data simply supplementing existing event data. In such instances, subsequent steps detailed in FIG. 6 are recomputed (e.g., the computation of correction weights as disclosed below) on a recurring basis as new event data is collected.

Next, a correction weight is determined for each respective correction type associated with the set of message categories using at least (i) the initial message category for each respective message in the first plurality of messages assigned by the first classifier, (ii) the initial message category for each respective message in the second plurality of messages assigned by the second classifier, and (iii) the plurality of recipient initiated message category correction events (628). In some embodiments, the plurality of recipient initiated message category correction events is from a single aggregation window. In some embodiments, the plurality of recipient initiated message category correction events is all recipient initiated message category correction events collected to date.

In some embodiments, the determining a correction weight for each respective correction type associated with the set of message categories comprises solving the loss function:

loss=Σ_{i,j≠i,m}(p_{i,j,m}−w_{i,j}·c_{i,j,m}/Nₘ)²+Σ_{i,m}(Σⱼp_{i,j,m}−c_{i,j,m}/Nₘ)²+Σ_{j,k}(Σᵢp_{i,j,2k}−p_{i,j,2k+1})²

for the correction weight, where m is in the range 0≦m<2K, K is the number of message reputation carriers in the plurality of message reputation carriers, observations 2k and 2k+1 are associated with the same message reputation carrier in the plurality of message reputation carriers, k is in the range 0≦k<K, i and j are the i^{th} and j^{th} message categories in the set of message categories, w_{i,j} is a respective correction weight associated with the set of message categories for correction between the i^{th} and j^{th} message categories in the set of message categories, the first or second classifier initially classifies a message as message category i and recipients in the plurality of recipients then classify the message as message category j, p_{i,j,m} is the probability that recipients in the plurality of recipients will reclassify a message from sender m, which has initially been categorized by the first or second classifier as being in message category i, to category j, c_{i,j,m} is the number of messages associated with observation m that recipients in the plurality of recipients change from the message category i, which was assigned by the first or second classifier to the message category j, Nₘ is the number of messages in the combination of the first plurality of messages and the second plurality of messages that are associated with observation m, p_{i,j,2k} is the probability that recipients in the plurality of recipients will reclassify a message associated with message reputation carrier k, which has initially been categorized by the first classifier as being in message category i, to category j, and p_{i,j,2k+1} is the probability that recipients in the plurality of recipients will reclassify a message associated with message reputation carrier k, which has initially been categorized by the second classifier as being in message category i, to category j (630). In some embodiments, the correction weights are forced to be equal (632). In some embodiments, the loss function is regularized (634). In some embodiments, the loss function is solved by a gradient descent approach (636).

In some embodiments, a correction weight for each respective correction type associated with the set of message categories is determined by minimizing a loss function that comprises (i) the initial message category for each respective message in the first plurality of messages assigned by the first classifier, (ii) the initial message category for each respective message in the second plurality of messages assigned by the second classifier and (iii) the recipient initiated message category correction events for messages in the first and second plurality of messages. In some such embodiments this loss function is evaluated by a gradient descent approach for the correction weight for each respective correction type associated with the set of message categories (638). In some embodiments, the gradient descent approach is a Newton method, a Broyden-Fletcher-Goldfarb-Shanno (BFGS) algorithm, or a limited memory BFGS algorithm (640).

The above discussion has addressed situations in which respective messages associated with each of a plurality of message reputation carriers are paired in the aggregate (e.g., a first confusion matrix of messages associated with a given message reputation carrier in the first plurality of messages and a second confusion matrix for messages associated with the same message reputation carrier in the second plurality of messages), thereby constituting a first and second plurality of messages that are respectively categorized by first and second classifiers in order to overdetermine a system of equations and thereby calculate correction weights to compensate for partial user feedback rather than complete user feedback. However, it is possible to use additional data beyond just the first and second plurality of messages. For instance, in some embodiments, each message in a third plurality of messages is classified using a third classifier, thereby independently identifying an initial message category in the set of message categories for each respective message in the third plurality of messages. The third plurality of messages includes at least one message from each message reputation carrier in the plurality of message reputation carriers. In some embodiments, this third classifier is the same as either the first or second classifier but differs only in the sense that a unique subset of the message reputation carriers in the plurality of message reputation carriers is whitelisted when the third plurality of messages is classified by the third classifier. In some embodiments, the third classifier is a completely different classifier than the first or the second classifier. In some embodiments, the third classifier consists of a single classifier and this classifier is the same as found in the first or second classifier with the exception that one or more parameters associated with the classifier are different in the third classifier. In accordance with embodiments in which a third plurality of messages from the plurality of senders is classified by a third classifier the delivering further comprises delivering the third plurality of messages to the plurality of recipients with a designation of the message category of each respective message in the third plurality of messages, as respectively determined by the third classifier. Furthermore, in such embodiments, the collecting the plurality of recipient initiated message category correction events comprises collecting the plurality of recipient initiated message category correction events for messages in the first, second, and third plurality of messages. Further, the determining the correction weight for each respective correction type associated with the set of message categories in such embodiments further uses the initial message category for each respective message in the third plurality of messages assigned by the third classifier (642).

There is no upper limit to the numbers of pluralities of messages respectively associated with individual message reputation carriers in the plurality of message reputation carriers that can be used in the methods of the present disclosure, each such plurality of messages being processed by a unique respective classifier. Explicit disclosure for the use case of a first and second plurality of messages, and for a first, second, and third plurality of messages has been described. Further, element 644 of FIG. 6 describes the use case of a first, second, third, and fourth plurality of messages. From this, one of skill in the art can see how to integrate the information from any number of pluralities of messages, in turn associated a given plurality of message reputation carriers, each such plurality of messages being processed by a different classifier, or the same classifier for which parameters have been adjusted in some unique way (or used during a disjoint time interval) for a respective instance of the classifier. Turning to element 646, optionally, in some such embodiments, each message in a fourth plurality of messages is classified using a fourth classifier, thereby independently identifying an initial message category in the set of message categories for each respective message in the fourth plurality of messages. The fourth plurality of messages includes at least one respective message associated with each message reputation carrier in the plurality of message reputation carriers (e.g., at least one message from each sender in a plurality of senders). In such embodiments, the delivering further comprises delivering the fourth plurality of messages to the plurality of recipients with a designation of the message category of each respective message in the fourth plurality of messages, as respectively determined by the fourth classifier. Further, in such embodiments, the collecting the plurality of recipient initiated message category correction events comprises collecting the plurality of recipient initiated message category correction events for messages in the first, second, third and fourth plurality of messages. Further still, the determining the correction weight for each respective correction type associated with the set of message categories further uses the initial message category for each respective message in the fourth plurality of messages assigned by the fourth classifier (644).

The method continues with the use of a correction weight for a correction type associated with the set of message categories to determine a probability or likelihood that the first message reputation carrier is associated with the first message category in the set of message categories (646). For example, in some embodiments, the probability or likelihood, P(C=k), that the first message reputation carrier is associated with the first message category in the set of message categories, using a correction weight for a correction type associated with the set of message categories, is determined by:

P(C=k)=(Σ_{i≠k}cᵢₖ·qᵢₖ⁻¹−Σ_{j≠k}cₖⱼ·qₖⱼ⁻¹+Σⱼcₖⱼ)/N

where k is the first message category, qᵢₖ⁻¹ is a correction weight for messages assigned by the first or second classifier to message category i that are then assigned by message recipients to message category k, where i is not equal to k, and i is a message category in the set of message categories. The symbol qₖⱼ⁻¹ is a correction weight for messages assigned by the first or second classifier to message category k that are then assigned by message recipients to message category j, where k is not equal to j, and j is a message category in the set of message categories, Cᵢₖ is a count of messages in the first and second plurality of messages that are assigned by the first or second classifier to message category i that are then assigned by message recipients to message category k, cₖⱼ is a count of messages in the first and second plurality of messages that are assigned by the first or second classifier to message category k that are then assigned by message recipients to message category j, and N is the number of messages in the first and second plurality of messages that are associated with the first message reputation carrier.

The method continues with the whitelisting of the first message reputation carrier to the first message category when the calculated probability or likelihood satisfies a whitelisting criterion (648). In some embodiments, the whitelisting criterion is a threshold probability or likelihood, and the calculated probability or likelihood satisfies the whitelisting criterion when the calculated probability or likelihood is equal to or greater than the threshold probability or likelihood (650). In some embodiments, upon whitelisting the first message reputation carrier to the first message category, each message in a third plurality of messages associated with the first message reputation carrier is classified into the whitelisted message category for the first message reputation carrier, and this classified third plurality of messages is delivered to recipients specified by the third plurality of messages (652).

There are a great number of uses for the correction weights and for the determination that certain message reputation carriers should be whitelisted in accordance with the systems and methods of the present disclosure. Such information can be used to retrain or further train, or otherwise influence the classifiers that are used to categorize messages (e.g., the first classifier, the second classifier or other classifiers). For example, in some optional embodiments, the first classifier and the second classifier are the same classifier and this classifier is retrained using the probability or likelihood that the first message reputation carrier is associated with the first message category in the set of message categories (654).

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the implementation(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the implementation(s).

It will also be understood that, although the terms “first,” “second,” etc. may be used herein to describe various elements, these elements should not be limited by these terms. These terms are only used to distinguish one element from another. For example, a first object could be termed a second object, and, similarly, a second object could be termed a first object, without changing the meaning of the description, so long as all occurrences of the “first object” are renamed consistently and all occurrences of the “second object” are renamed consistently. The first object and the second object are both objects, but they are not the same object.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

Throughout this disclosure, a primary example of the grounding characteristic (message reputation carrrier) of each message was the sender of each message. In some embodiments, a message reputation carrier in the plurality of message reputations is the identity of an actual person. In some embodiments, a message reputation carrier in the plurality of message reputations is the identity of business or government organization. In some embodiments, a message reputation carrier in the plurality of message reputation carriers is a URL, IP address, or MAC address. In some embodiments, a message reputation carrier in the plurality of message reputation carriers is the identity of a group (plurality) of people. In some embodiments, a message reputation carrier in the plurality of message reputation carriers is the identity of a group (plurality) of businesses and/or government organizations. In some embodiments, a message reputation carrier in the plurality of reputation carriers is a group (plurality) of URLs, IP addresses, or MAC addresses. Still further, in some embodiments, rather than using the grounding characteristic of message sender identity, some other grounding characteristic, such as unique message content is used (e.g., message template). So for example, all messages that contain the word “carrot” or a particular form, and/or style would be analyzed in a manor equivalent to considering such messages as being associated with the same message reputation carrier, and those messages that contain the word “orange” would be analyzed in a manor equivalent to considering these messages as being associated with a different second message reputation carrier. Here the goal would be to determine if messages, irrespective of who the original sender was, that contain the word “orange” should be whitelisted to a particular category. As such, it will be appreciated that the disclosed systems and methods are not limited to whitelisting based on the property of message sender, but indeed any property of messages, such as message content.

The foregoing description included example systems, methods, techniques, instruction sequences, and computing machine program products that embody illustrative implementations. For purposes of explanation, numerous specific details were set forth in order to provide an understanding of various implementations of the inventive subject matter. It will be evident, however, to those skilled in the art that implementations of the inventive subject matter may be practiced without these specific details. In general, well-known instruction instances, protocols, structures and techniques have not been shown in detail.

The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles and their practical applications, to thereby enable others skilled in the art to best utilize the implementations and various implementations with various modifications as are suited to the particular use contemplated.

What is claimed is:

1. A method of whitelisting a first message reputation carrier to a first message category in a set of message categories, the method comprising:
at a computer system having one or more processors, and memory storing one or more programs for execution by the one or more processors:
classifying each message in a first plurality of messages using a first classifier, thereby independently identifying an initial message category in the set of message categories for each respective message in the first plurality of messages, wherein the first plurality of messages includes, for each respective message reputation carrier in a plurality of message reputation carriers, at least one message associated with the respective message reputation carrier and wherein the plurality of message reputation carriers includes the first message reputation carrier;
classifying each message in a second plurality of messages using a second classifier, thereby independently identifying an initial message category in the set of message categories for each respective message in the second plurality of messages, wherein the second plurality of messages includes, for each respective message reputation carrier in the plurality of message reputation carriers, at least one message associated with the respective message reputation carrier;
delivering the first and second plurality of messages to a plurality of recipients with a designation of the message category of each respective message in the first and second plurality of messages, as respectively determined by the first and second classifier;
collecting a plurality of recipient initiated message category correction events for messages in the first and second plurality of messages;
determining a correction weight for each respective correction type associated with the set of message categories using at least (i) the initial message category for each respective message in the first plurality of messages assigned by the first classifier, (ii) the initial message category for each respective message in the second plurality of messages assigned by the second classifier and (iii) the plurality of recipient initiated message category correction events;
using the correction weight for each correction type associated with a message category in the set of message categories to determine a probability or likelihood that the first message reputation carrier is associated with the first message category in the set of message categories; and
whitelisting the first message reputation carrier to the first message category when the calculated probability or likelihood satisfies a whitelisting criterion.

2. The method of claim 1, wherein the set of message categories comprises promotions, social, updates, and forums.

3. The method of claim 1, wherein
the first classifier and the second classifier are the same classifier,
the first plurality of messages is classified by the classifier at a time before a subset of message reputation carriers in the plurality of message reputation carriers are whitelisted to message categories in the set of message categories, and
the second plurality of messages is classified by the classifier at a time after the subset of message reputation carriers in the plurality of message reputation carriers are whitelisted to message categories.

4. The method of claim 1, wherein the determining a correction weight for each respective correction type associated with the set of message categories comprises minimizing the loss function:
$$loss = {\sum }_{i , j \neq i , m} {( {p}_{i , j , m} - {w}_{i , j} \cdot {c}_{i , j , m} / {N}_{m} )}^{2} + {\sum }_{i , m} {( {\sum }_{j} {p}_{i , j , m} - {c}_{i , j , m} / {N}_{m} )}^{2} + {\sum }_{j , k} {( {\sum }_{i} {p}_{i , j , 2 k} - {p}_{i , j , 2 k + 1} )}^{2}$$
for the correction weight, wherein
m is in the range 0≦m<2K, wherein K is the number of message reputation carriers in the plurality of message reputation carriers, observations 2k and 2k+1 are associated with the same message reputation carrier in the plurality of message reputation carriers, and k is in the range 0≦k<K,
i and j are the i^{th} and j^{th} message categories in the set of message categories, wᵢⱼ is a respective correction weight associated with the set of message categories for correction between the i^{th} and j^{th} message categories in the set of message categories, wherein the first or second classifier initially classifies a message as message category i and recipients in the plurality of recipients then classify the message as message category j,
p_{i,j,m} is the probability that recipients in the plurality of recipients will reclassify a message associated with observation m, which has initially been categorized by the first or second classifier as being in message category i, to category j,
c_{i,j,m} is the number of messages associated with observation m that recipients in the plurality of recipients change from the message category i, which was assigned by the first or second classifier, to the message category j,
Nₘ is the number of messages in the combination of the first plurality of messages and the second plurality of messages that are associated with observation m,
p_{i,j,2k} is the probability that recipients in the plurality of recipients will reclassify a message associated with observation k, which has initially been categorized by the first classifier as being in message category i, to category j, and
p_{i,j,2k+1} is the probability that recipients in the plurality of recipients will reclassify a message associated with observation k, which has initially been categorized by the second classifier as being in message category i, to category j.

5. The method of claim 4, wherein, the corrections weights are forced to be equal.

6. The method of claim 4, wherein, the loss function is regularized.

7. The method of claim 1, wherein the determining a correction weight for each respective correction type associated with the set of message categories comprises minimizing a loss function of the form:
$$loss = {\sum }_{i , j \neq i , m} {( {p}_{i , j , m} - {w}_{f ( i , j )} \cdot {c}_{i , j , m} / {N}_{m} )}^{2} + {\sum }_{i , m} {( {\sum }_{j} {p}_{i , j , m} - {c}_{i , j , m} / {N}_{m} )}^{2} + {\sum }_{j , k} {( {\sum }_{i} {p}_{i , j , 2 k} - {p}_{i , j , 2 k + 1} )}^{2} + λ {\sum }_{i} {w}_{i}^{2}$$
for the respective correction weight, wherein
m is in the range 0≦m<2K, K is the number of message reputation carriers in the plurality of message reputation carriers, observations 2k and 2k+1 are associated with the same message reputation carrier in the plurality of message reputation carriers, and k is in the range 0≦k<K,
i and j are the i^{th} and j^{th} message categories in the set of message categories,
w_{f(i,j)} is a respective correction weight associated with the set of message categories for correction between any first and second message categories in the set of message categories, wherein the first or second classifier initially classifies a message to the first message category and recipients in the plurality of recipients then classify the message to the second message category,
p_{i,j,m} is the probability that recipients in the plurality of recipients will reclassify a message associated with observation m, which has initially been categorized by the first or second classifier as being in message category i, to category j,
c_{i,j,m} is the number of messages associated with observation m that recipients in the plurality of recipients change from the message category i, which was assigned by the first or second classifier, to the message category j,
Nₘ is the number of messages in the combination of the first plurality of messages and the second plurality of messages that are associated with observation m,
p_{i,j,2k} is the probability that recipients in the plurality of recipients will reclassify a message associated with observation k, which has initially been categorized by the first classifier as being in message category i, to category j,
p_{i,j,2k+1} is the probability that recipients in the plurality of recipients will reclassify a message associated with observation k, which has initially been categorized by the second classifier as being in message category i, to category j,
λ is a constant, and
wᵢ² is a weight constant for message category i.

8. The method of claim 7, wherein the loss function is evaluated by a gradient descent approach.

9. The method of claim 1, wherein the determining a correction weight for each respective correction type associated with the set of message categories comprises:
minimizing, as a loss function, empirical data comprising (i) the initial message category for each respective message in the first plurality of messages assigned by the first classifier (ii) the initial message category for each respective message in the second plurality of messages assigned by the second classifier, and (iii) the recipient initiated message category correction events for messages in the first and second plurality of messages against a set of model parameters, by a gradient descent approach for the correction weight for each respective correction type associated with the set of message categories.

10. The method of claim 9, wherein the gradient descent approach is a Newton method, a Broyden-Fletcher-Goldfarb-Shanno (BFGS) algorithm, or a limited memory BFGS algorithm.

11. The method of claim 1, wherein the determination of the probability or likelihood, P(C=k), that the first message reputation carrier is associated with the first message category in the set of message categories, using a correction weight for a correction type associated with the set of message categories, is determined by:
$$P ( C = k ) = ( {\sum }_{i \neq k} {c}_{ik} \cdot {q}_{ik}^{- 1} - {\sum }_{j \neq k} {c}_{jk} \cdot {q}_{kj}^{- 1} + {\sum }_{j} {c}_{kj} ) / N$$
wherein,
k is the first message category,
qᵢₖ⁻¹ is a correction weight for messages assigned by the first or second classifier to message category i that are then assigned by message recipients to message category k, wherein i≠k, and i is a message category in the set of message categories,
qₖⱼ⁻¹ is a correction weight for messages assigned by the first or second classifier to message category k that are then assigned by message recipients to message category j, wherein k≠j, and j is a message category in the set of message categories,
cᵢₖ is a count of messages in the first and second plurality of messages that are assigned by the first or second classifier to message category i that are then assigned by message recipients to message category k,
cₖⱼ is a count of messages in the first and second plurality of messages that are assigned by the first or second classifier to message category k that are then assigned by message recipients to message category j, and
N is the number of messages in the first and second plurality of messages that are associated with the first message reputation carrier.

12. The method of claim 1, the method further comprising:
upon whitelisting the first message reputation carrier to the first message category,
classifying each message in a third plurality of messages associated with the first message reputation carrier into the whitelisted message category for the first message reputation carrier, and
delivering the classified third plurality of messages to recipients specified by the third plurality of messages.

13. The method of claim 1, wherein
the whitelisting criterion is a threshold probability or likelihood, and
the calculated probability or likelihood satisfies the whitelisting criterion when the calculated probability or likelihood is equal to or greater than the threshold probability or likelihood.

14. The method of claim 1, wherein
the first classifier and the second classifier are a single neural network with the same trained weights,
the first plurality of messages are classified by the neural network at a time before at least a subset of message reputation carriers in the plurality of message reputation carriers are whitelisted to message categories in the set of message categories, and
the second plurality of messages are classified by the neural network at a time after the subset of message reputation carriers in the plurality of message reputation carriers are whitelisted to message categories.

15. The method of claim 1, wherein the first classifier and the second classifier are the same classifier and the method further comprises retraining the classifier using the probability or likelihood that the first message reputation carriers is associated with the first message category in the set of message categories.

16. The method of claim 1, wherein the first category is one of promotions, social, updates, and forums.

17. The method of claim 1, wherein each recipient in the plurality of recipients is associated with a different client in a plurality of clients and wherein the delivering the first and second plurality of messages comprises delivering each respective message in the first and second plurality of messages to the client in the plurality of clients that is associated with the respective message.

18. The method of claim 1, wherein the first classifier is a single first classifier and the second classifier is a single second classifier.

19. The method of claim 18, wherein the first classifier and the second classifier are the same.

20. The method of claim 18, wherein the first classifier is different than the second classifier.

21. The method of claim 18, wherein the first classifier and the second classifier are the same classifier and wherein the first classifier and the second classifier are used in disjoint or different time periods.

22. The method of claim 1, the method further comprising:
classifying each message in a third plurality of messages using a third classifier, thereby independently identifying an initial message category in the set of message categories for each respective message in the third plurality of messages, wherein the third plurality of messages includes, for each respective message reputation carrier in the plurality of message reputation carriers, at least one message associated with the respective message reputation carrier, and wherein
the delivering further comprises delivering the third plurality of messages to the plurality of recipients with a designation of the message category of each respective message in the third plurality of messages, as respectively determined by the third classifier,
the collecting the plurality of recipient initiated message category correction events comprises collecting the plurality of recipient initiated message category correction events for messages in the first, second, and third plurality of messages, and
the determining the correction weight for each respective correction type associated with the set of message categories further uses the initial message category for each respective message in the third plurality of messages assigned by the third classifier.

23. The method of claim 21, the method further comprising:
classifying each message in a fourth plurality of messages using a fourth classifier thereby independently identifying an initial message category in the set of message categories for each respective message in the fourth plurality of messages, wherein the fourth plurality of messages includes, for each respective message reputation carrier in a the plurality of message reputation carriers, at least one message associated with the respective message reputation carrier in the plurality of message reputation carriers, and wherein
the delivering further comprises delivering the fourth plurality of messages to the plurality of recipients with a designation of the message category of each respective message in the fourth plurality of messages, as respectively determined by the fourth classifier,
the collecting the plurality of recipient initiated message category correction events comprises collecting the plurality of recipient initiated message category correction events for messages in the first, second, third and fourth plurality of messages, and
the determining the correction weight for each respective correction type associated with the set of message categories further uses the initial message category for each respective message in the fourth plurality of messages assigned by the fourth classifier.

24. The method of claim 1, wherein
the first classifier and the second classifier are the same classifier,
the classifying each message in the first plurality of messages by the first classifier occurs during a first time interval [t₁, . . . t₂], and
the classifying each message in the second plurality of messages by the second classifier occurs during a second time interval [t₃, . . . t₄] disjoint from the first interval, wherein t₂<t₃.

25. The method of claim 24, wherein the first classifier evolves during the first time interval and the second classifier evolves in the second time interval.

26. The method of claim 1, wherein each respective message reputation carrier in the plurality of message reputation carriers is an identity of a message sender.

27. The method of claim 26, wherein the message sender is an identity of an actual person, an identity of a business, an identity of a plurality of businesses, an identity of a government organization, an identity of a group of government organizations, an identity of a plurality of people, a URL, an IP address, or a MAC address.

28. The method of claim 1, where each respective message reputation carrier in the plurality of message reputations is based on message content.

29. A computing system, comprising:
one or more processors;
memory storing one or more programs to be executed by the one or more processors;
the one or more programs comprising instructions for:
classifying each message in a first plurality of messages using a first classifier thereby independently identifying an initial message category in a set of message categories for each respective message in the first plurality of messages, wherein the first plurality of messages includes, for each respective message reputation carrier in a plurality of message reputation carriers, at least one message associated with the respective message reputation carrier;
classifying each message in a second plurality of messages using a second classifier, thereby independently identifying an initial message category in the set of message categories for each respective message in the second plurality of messages, wherein the second plurality of messages includes, for each respective message reputation carrier in the plurality of message reputation carriers, at least one message associated with the respective message reputation carrier;
delivering the first and second plurality of messages to a plurality of recipients with a designation of the message category of each respective message in the first and second plurality of messages, as respectively determined by the first and second classifier;
collecting a plurality of recipient initiated message category correction events for messages in the first and second plurality of messages;
determining a correction weight for each respective correction type associated with the set of message categories using at least (i) the initial message category for each respective message in the first plurality of messages assigned by the first classifier, (ii) the initial message category for each respective message in the second plurality of messages assigned by the second classifier, and (iii) the plurality of recipient initiated message category correction events;
using the correction weight for each correction type associated with the set of message categories to determine a probability or likelihood that a first message reputation carrier in the plurality of message reputation carriers is associated with a first message category in the set of message categories; and
whitelisting the first message reputation carrier to the first message category when the calculated probability or likelihood satisfies a whitelisting criterion.

30. A non-transitory computer readable storage medium storing one or more programs configured for execution by a computer, the one or more programs comprising instructions for:
classifying each message in a first plurality of messages using a first classifier, thereby independently identifying an initial message category in a set of message categories for each respective message in the first plurality of messages, wherein the first plurality of messages includes, for each respective message reputation carrier in a plurality of message reputation carriers, at least one message associated with the respective message reputation carrier;
classifying each message in a second plurality of messages using a second classifier, thereby independently identifying an initial message category in the set of message categories for each respective message in the second plurality of messages, wherein the second plurality of messages includes, for each respective message reputation carrier in the plurality of message reputation carriers, at least one message associated with the respective message reputation carrier;
delivering the first and second plurality of messages to a plurality of recipients with a designation of the message category of each respective message in the first and second plurality of messages, as respectively determined by the first and second classifier;
collecting a plurality of recipient initiated message category correction events for messages in the first and second plurality of messages;
determining a correction weight for each respective correction type associated with the set of message categories using at least (i) the initial message category for each respective message in the first plurality of messages assigned by the first classifier, (ii) the initial message category for each respective message in the second plurality of messages assigned by the second classifier, and (iii) the plurality of recipient initiated message category correction events;
using the correction weight for each correction type associated with the set of message categories to determine a probability or likelihood that a first message reputation carrier in the plurality of message reputation carriers is associated with a first message category in the set of message categories; and
whitelisting the first message reputation carrier to the first message category when the calculated probability or likelihood satisfies a whitelisting criterion.
